(19) United States
(12) Patent Application Publication
(10) Pub. No.: US 2023/0406677 A1
(43) Pub. Date: Dec. 21, 2023

(54) BOOM VEHICLE WITH VERTICALLY AND LATERALLY FOLDABLE BOOM ASSEMBLY

(71) Applicant: Anders RAGNARSSON, Rye, NH (US)

(72) Inventor: Anders RAGNARSSON, Rye, NH (US)

(73) Assignee: Ragnartech Inc., Fremont, NH (US)

(21) Appl. No.: 18/249,746

(22) PCT Filed: Nov. 12, 2021
(86) PCT No.: PCT/US2021/059101

§ 371 Date: Apr. 20, 2023

Related U.S. Application Data
(60) Provisional application No. 63/113,493, filed on Nov. 13, 2020.

(51) Int. Cl. B66C 23/42; B66C 23/00; B66C 23/70

(52) U.S. Cl. CPC B66C 23/42; B66C 23/54; B66C 23/702

(57) ABSTRACT

A boom vehicle which comprises a vehicle framework; a boom/cab framework being rotatably supporting by the vehicle framework; a combined boom/arm being pivotably supported by the boom/cab framework about a boom/arm pivot axis; the combined boom/arm comprising at least a base telescoping section, a first pivoting arm section, and an implement manipulating section; and an implement being supportable adjacent a free end of the combined boom/arm. The first pivoting arm section and the implement manipulating section together being laterally foldable, with respect to the base telescoping section, about a lateral folding pivot axis which extends normal to the combined boom/arm pivot axis to facilitate transport of the boom vehicle with respect to the base telescoping section to facilitate transport of the boom vehicle along a roadway.

### FIELD OF THE INVENTION

The present disclosure relates to a boom vehicle which comprises a rotatable boom/cab framework that supports a boom cab and a combined boom/arm, the combined boom/arm comprises at least a base telescoping section, a pivoting arm section, and an implement (telescoping) section. The pivoting arm section is laterally foldable with respect to the base telescoping section so as to result in a compact folded and travel configuration which facilitates transport of the boom vehicle from one site to another.

### BACKGROUND OF THE INVENTION

There are a variety of boom vehicles which have booms that are currently available in the market. Most of such known boom vehicles generally only allow the supported boom to facilitate raising and/or lowering material. However, none of the currently available boom vehicles are designed to facilitate manipulation of any material either on the ground and/or in close proximity to the boom vehicle. As such, these currently available boom vehicles have limited utility.

### SUMMARY OF THE INVENTION

Wherefore, it is an object of the present disclosure to overcome the above mentioned shortcomings and drawbacks associated with the prior art boom vehicles and permit manipulation and handling of material on the ground and/or in close proximity to the boom vehicle.

A further object of the present disclosure is to provide the boom vehicle which has a combined boom/arm which has an extended reach while, at the same time, is easily and readily collapsing into a compact travel configuration to facilitate transport of the boom vehicle from one job site to another.

Another object of the present disclosure is to provide the combined boom/arm as three separate and distinct sections so as to improve the overall versatility and improve manipulation of a desired implement supported at the free end of combined boom/arm.

Yet a further object of the present disclosure is to provide a sufficiently robust and durable combined boom/arm so as to permit use of the same for a variety of different applications, such as removing sections of a tree or a complete tree, performing demolition of the building or some other structure, etc.

The present invention also relates to a boom vehicle comprising: a vehicle framework; a boom/cab framework being rotatably supporting by the vehicle framework; a combined boom/arm being pivotably supported by the boom/cab framework about a boom/arm pivot axis; the combined boom/arm comprising at least a base telescoping section, a first pivoting arm section, and an implement manipulating section; an implement being supportable adjacent a free end of the combined boom/arm; and the first pivoting arm section and the implement manipulating section together being laterally foldable, with respect to the base telescoping section, about a lateral folding pivot axis which extends normal to the combined boom/arm pivot axis to facilitate transport of the boom vehicle.

The present invention also relates to a boom vehicle comprising: a vehicle framework; a boom/cab framework being rotatably supporting by the vehicle framework; a boom cab being supported on the boom/cab framework; a combined boom/arm being pivotably supported by the boom/cab framework about a boom/arm pivot axis; the combined boom/arm comprising at least a base telescoping section, a first pivoting arm section, a second pivoting section and an implement manipulating section; an implement being supportable adjacent a free end of the combined boom/arm; the first pivoting arm section, the second pivoting section and the implement manipulating section together being laterally foldable into a folded configuration, with respect to the base telescoping section, about a lateral folding pivot axis which extends normal to the combined boom/arm pivot axis; and when the combined boom/arm is in the folded configuration, the base telescoping section, the first pivoting arm section and a portion of the second pivoting section all lie in a common horizontal plane, and the first pivoting arm section, the second pivoting section and the implement manipulating section all lie in a common vertical plane.

The present invention finally relates to a method of forming a boom vehicle, the method comprising: providing a vehicle framework; rotatably supporting a boom/cab framework on the vehicle framework; supporting a boom cab on the boom/cab framework; pivotably supporting a combined boom/arm on the boom/cab framework so as to rotate about a boom/arm pivot axis; forming the combined boom/arm so as to comprise at least a base telescoping section, a first pivoting arm section, a second pivoting section and an implement manipulating section; supporting an implement adjacent a free end of the combined boom/arm; forming the first pivoting arm section, the second pivoting section and the implement manipulating section so as to be laterally foldable into a folded configuration, with respect to the base telescoping section, about a lateral folding pivot axis which extends normal to the combined boom/arm pivot axis; and upon folding the combined boom/arm into the folded configuration, the base telescoping section, the first pivoting arm section and a portion of the second pivoting section all lie in a common horizontal plane, and the first pivoting arm section, the second pivoting section and the implement manipulating section all lie in a common vertical plane.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. The invention will now be described, by way of example, with reference to the accompanying drawings in which:

FIG. 1 is a diagrammatic right side elevational view of the boom vehicle, supporting a combined boom/arm having an implement supported at the free end thereof, with the combined boom/arm shown in its fully extended and operating configuration;

FIG. 2 is a diagrammatic right side elevational view of the boom vehicle showing complete retraction of both the implement telescoping section and the base telescoping section of the combined boom/arm as a first step in preparation for storage and/or transportation of the boom vehicle;

FIG. 3 is a diagrammatic right side elevational view of the boom vehicle showing complete folding of the implement telescoping section of the combined boom/arm as a second step in preparation for storage and/or transportation of the boom vehicle;

FIG. 4 is a diagrammatic right side elevational view of the boom vehicle showing the combined boom/arm, with the complete folded the implement telescoping section, being lowered into a substantially horizontal configuration, during a third step in preparation for storage and/or transportation of the boom vehicle, to facilitate removal of the first pin/bolt;

FIG. 4A is a diagrammatic top plan view of FIG. 4 showing the combined boom/arm, with the complete folded the implement telescoping section, being lowered into a substantially horizontal configuration, during a third step;

FIG. 5 is a diagrammatic top plan view showing the both the pivoting arm section and the implement telescoping section laterally folded, during a fourth step, relative to the base telescoping section;

FIG. 6 is a diagrammatic left side elevational view of the boom vehicle showing the combined boom/arm in its completely folded and stored configuration, following completion of a fifth step, to facilitate travel of the boom vehicle position;

FIG. 6A is a top plan elevational view of FIG. 6;

FIG. 7 is a diagrammatic right side elevational view of the boom vehicle showing partial folding of the implement telescoping section of the combined boom/arm, while a remainder of the combined boom/arm remains in an axially aligned configuration;

FIG. 8 is a diagrammatic right side elevational view of the boom vehicle showing partial folding of both the implement telescoping section and the pivoting arm section of the combined boom/arm, while the base telescoping section remains in an axially aligned configuration;

FIG. 9 is a diagrammatic elevational view of only the boom cab and the combined boom/arm shown, with the implement and a remainder of the boom vehicle removed for reasons of clarity, showing the combined boom/arm in its fully extended position;

FIG. 10 is a diagrammatic right side elevational view of the boom vehicle of FIG. 1 with the combined boom/arm shown in its unfolded and fully extended operating position, without an implement being shown attached thereto, to provide maximum reach during a desired removal operation;

FIG. 11 is a diagrammatic right side elevational view of the boom vehicle of FIG. 10, showing the implement telescoping section and the base telescoping section of the combined boom/arm in their retracted positions;

FIG. 12 is a diagrammatic left side elevational view of a second embodiment of the boom vehicle, supporting a combined boom/arm having an implement supported at the free end thereof, with the combined boom/arm shown in its unfolded and travel configuration;

FIG. 12A is a diagrammatic front side elevational view of the second embodiment of FIG. 12 with the vehicle cab removed for reasons of clarity;

FIG. 13 is a diagrammatic top plan view of FIG. 12;

FIG. 14 is a diagrammatic left side elevational view of the boom vehicle of FIG. 12, supporting the combined boom/arm having an implement supported at the free end thereof, with the combined boom/arm shown in its partially unfolded configuration;

FIG. 15 is a diagrammatic top plan view of FIG. 14;

FIG. 16 is a diagrammatic front elevational view of the boom vehicle of FIG. 14;

FIG. 17 is a diagrammatic left side elevational view of the boom vehicle of FIG. 12, supporting the combined boom/arm having an implement supported at the free end thereof, with the combined boom/arm shown in its fully unfolded and axially aligned configuration the combined boom/arm extending horizontally;

FIG. 18 is a diagrammatic top plan view of the base telescoping section and a portion of the first pivoting arm section of FIG. 17;

FIG. 19 is a diagrammatic left side elevational view of the boom vehicle of FIG. 12, supporting the combined boom/arm having an implement supported at the free end thereof, with the combined boom/arm shown in its fully unfolded and axially aligned configuration but with the combined boom/arm shown in a raised position;

FIG. 20 is a diagrammatic left side elevational view of the second embodiment of the boom vehicle, supporting a combined boom/arm having an implement supported at the free end thereof, showing the combined boom/arm shown in a lower operating position;

FIG. 21 is a diagrammatic left side elevational view of the second embodiment of the boom vehicle, supporting a combined boom/arm having an implement supported at the free end thereof, showing the combined boom/arm shown in a raised operating position;

FIG. 22 is a diagrammatic left side elevational view of the second embodiment of the boom vehicle, supporting a combined boom/arm having an implement supported at the free end thereof, showing the combined boom/arm shown in another raised operating position;

FIG. 23A is a diagrammatic plan view showing first and second folding pistons/cylinders and a pivoting linkage for moving the pivoting arm section into its folded configuration parallel to the base telescoping section; and

FIG. 23B is a diagrammatic plan view showing the first and second folding pistons/cylinders and the pivoting linkage for moving the pivoting arm section into its operational position in which the pivoting arm section is axially aligned with the base telescoping section.

It should be understood that the drawings are not necessarily to scale and that the disclosed embodiments are sometimes illustrated diagrammatical and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION OF THE PREFERRED EMBODIMENTS

The present invention will be understood by reference to the following detailed description of the disclosure, which should be read in conjunction with the appended drawings. It is to be appreciated that the following detailed description of various embodiments is by way of example only and is not meant to limit, in any way, the scope of the present invention.

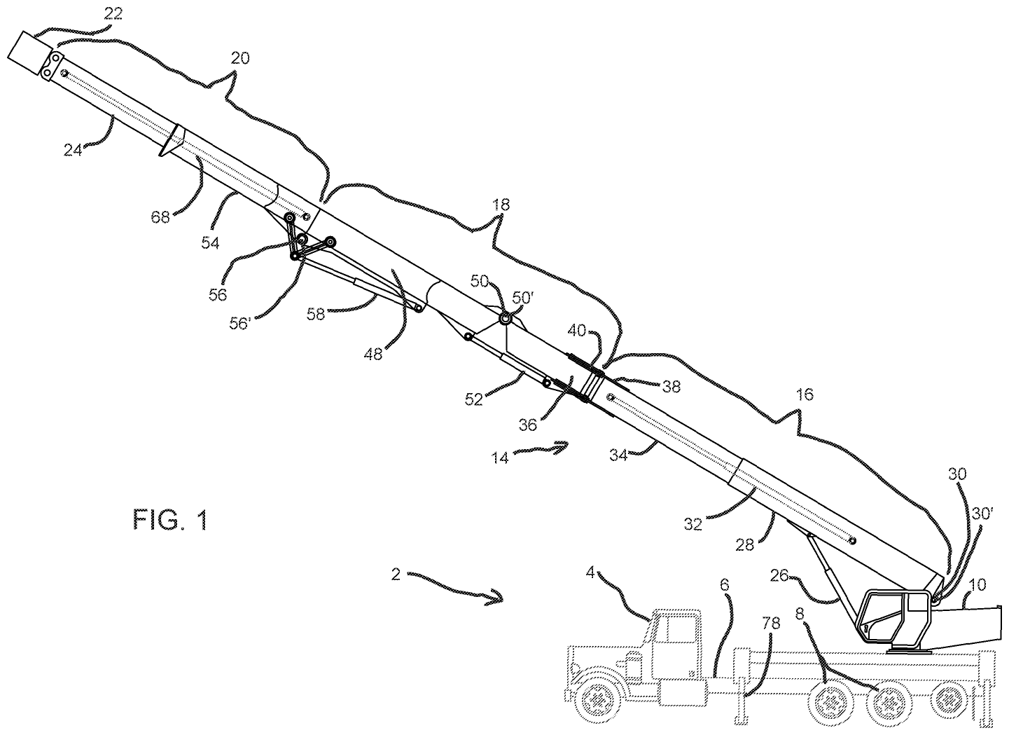

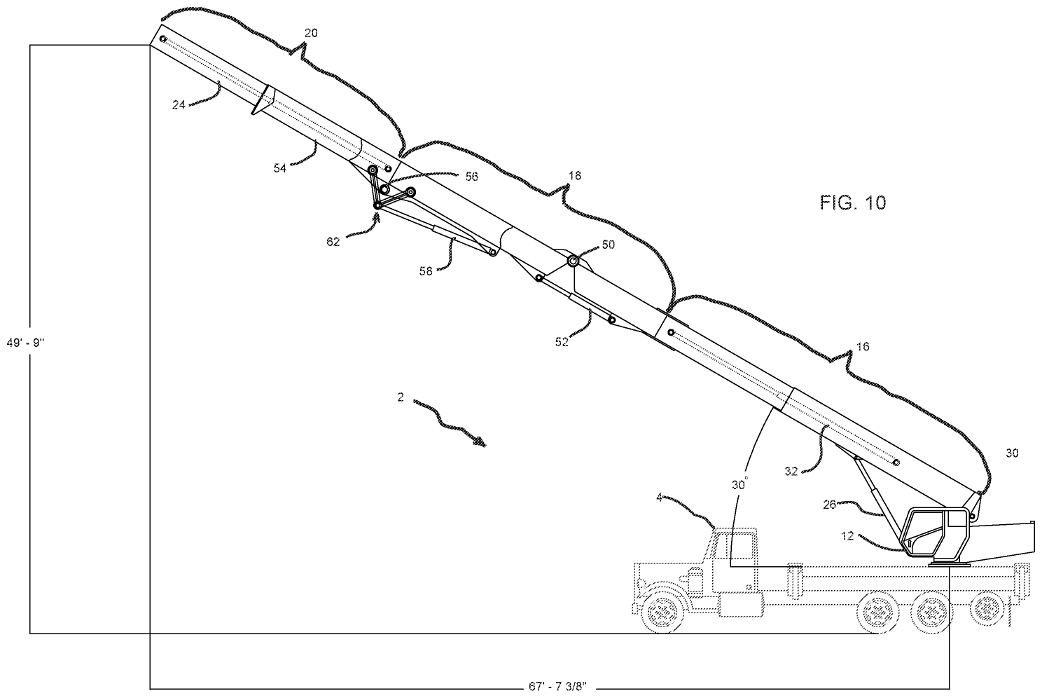

Turning first to FIGS. 1 and 9-11, a brief description concerning the various components of the present invention will now be briefly discussed. As can be seen in this embodiment, the present invention relates to a boom vehicle 2 which has a conventional vehicle cab 4, for accommodating at least a vehicle operator during transport of the boom vehicle 2 from one site or location to another site or location over a road or highway. In addition, the boom vehicle 2 also includes a vehicle framework 6 that supports a plurality of wheels 8 which are driven, in a conventional manner, by an engine (not shown) to facilitate movement of the boom vehicle 2 over a roadway or some other desired surface. A boom/cab framework 10 is rotatably supported by the vehicle framework 6 so that the boom/cab framework 10 can rotate, relative to the vehicle framework 6, during operation thereof, the purpose of such rotation will become apparent from the following discussion. A boom cab 12 is supported by and moves with the boom cab framework 10.

The combined boom/arm 14 is supported by the rotatable boom/cab framework 10 so as to move therewith. The combined boom/arm 14 generally comprises at least three boom sections, namely, a base telescoping section 16, a first pivoting arm section 18, and an implement telescoping section 20. A desired implement 22, such as a conventional grappler device, (with or without an integrated chain saw), a mobile chipper, a concrete pulverizing device, etc. (only diagrammatically shown in FIGS. 1-8, for example) is removably affixed, in a conventional manner, to a free end of the implement telescoping section 20 so that the desired implement 22 is able to rotate and/or pivot relative to the second end of an inner implement telescoping tube 24 of the implement telescoping section 20. A further detailed description concerning each of these components will now be provided.

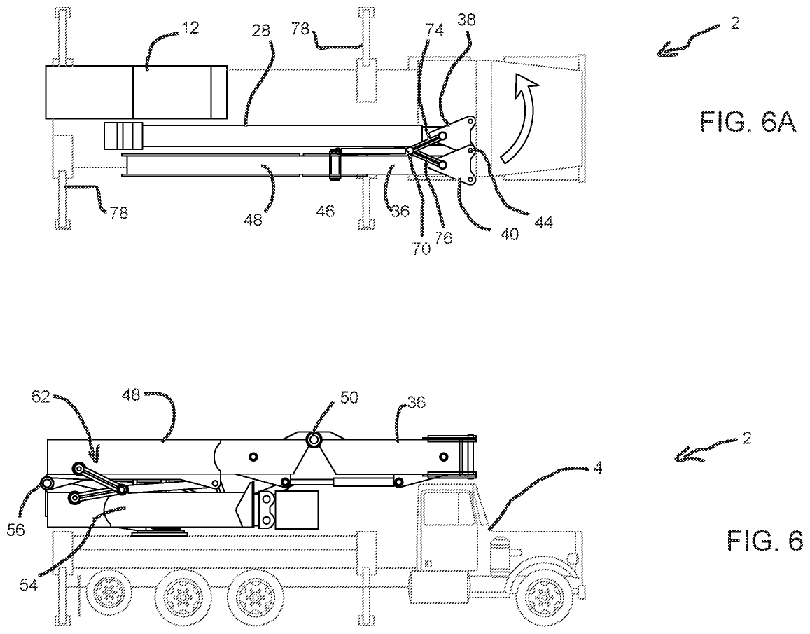

As diagrammatically shown, the boom/cab framework 10 is generally rotatably pivotally supported by the vehicle framework 6. That is, the boom/cab framework 10, which supports both the boom cab 12 and the combined boom/arm 14, is able to rotate relative to the vehicle framework 6 of the boom vehicle 2 over an angle of at least 90°, toward the left and toward the right from a central position shown in FIG. 6A, for example, and the boom/cab framework 10 may possibly be able to rotate, relative to the vehicle framework 6, over an angle of 360°. In addition, the boom cab 12 is provided with internal controls (not shown) for controlling operation of the combined boom/arm 14 as well as the supported implement 22, e.g., the internal controls facilitate raising and lowering the combined boom/arm 14, extending and retracting of the combined boom/arm 14, folding/unfolding of the combined boom/arm 14, operating, manipulating, rotating and/or pivoting of the supported implement 22, etc. As such rotation of the boom cab 12, relative to the vehicle framework 6, as well as operation of the supported implement 22 by the internal controls is conventional and fairly well known, a further discussion concerning those components and features is not provided.

A boom piston/cylinder 26 is provided for adjusting, e.g., raising and lowering, the position of the combined boom/arm 14, as well as the supported implement 22, relative to the boom/cab framework 10. A first end of the hollow outer telescoping tube 28 is pivotably connected to the boom/cab framework 10 by a combined boom/arm pin/bolt 30, for example. The combined boom/arm pin/bolt 30 defines a combined boom/arm pivot axis 30′ about which the entire combined boom/arm 14 pivots, about a horizontal axis, with respect to the boom/cab framework 10. As shown, a first cylinder end of the boom piston/cylinder 26 is pivotably affixed to the boom/cab framework 10, while an opposite piston end thereof is affixed to an intermediate section of the hollow outer telescoping tube 28 of the base telescoping section 16 of the combined boom/arm 14. When hydraulic fluid is supplied to a first end of the boom piston/cylinder 26, an overall length of the boom piston/cylinder 26 increases so that a second end of the hollow outer telescoping tube 28 is pivoted (along with a remainder of the combined boom/arm 14), about the combined boom/arm pivot axis 30′, upwardly relative to and away from the boom/cab framework 10 and the ground.

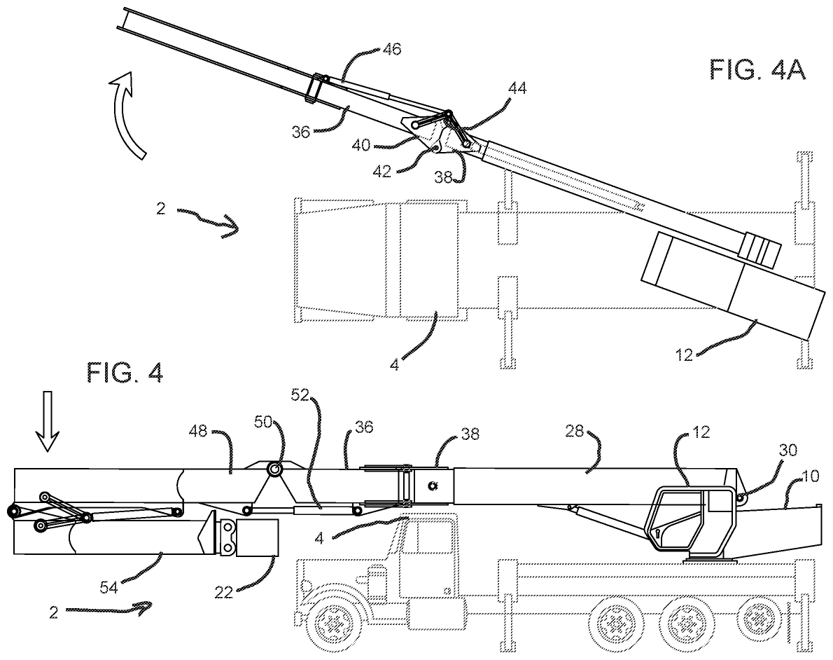

Alternatively, when hydraulic fluid is supplied to an opposite second end of the boom piston/cylinder 26, the overall length of the boom piston/cylinder 26 thereby decreases so that the second end of the hollow outer telescoping tube 28 pivots (along with a remainder of the combined boom/arm 14), about the combined boom/arm pivot axis 30′, downwardly relative to and toward the boom/cab framework 10 and the ground. The boom piston/cylinder 26 is generally able to manipulate or pivot the hollow outer telescoping tube 28, as well as the remainder of the combined boom/arm 14, relative to the boom/cab framework 10 and the ground, about an angle of 30° or so from a generally horizontal position, as shown in FIG. 4 for example, into a variety of elevated positions, as shown in FIGS. 1, 10 and 11.

A base telescoping piston/cylinder 32 is provided for extending and retracting the position of the hollow inner telescoping tube 34 relative to the hollow outer telescoping tube 28. As shown, a first cylinder end of the base telescoping piston/cylinder 32 is affixed to an exterior surface adjacent the first end of the hollow outer telescoping tube 28 while an opposite piston end thereof is affixed adjacent to a second end of the hollow inner telescoping tube 34. When hydraulic fluid is supplied to a first end of the base telescoping piston/cylinder 32, an overall axial length of the base telescoping piston/cylinder 32 increases so that the second end of the hollow inner telescoping tube 34 moves away from the second end of the hollow outer telescoping tube 28 so as to increase the overall length of the base telescoping section 16. Alternatively, when hydraulic fluid is supplied to an opposite second end of the base telescoping piston/cylinder 32, the overall axial length of the base telescoping piston/cylinder 32 thereby decreases so that the second end of the hollow inner telescoping tube 34 moves toward the second end of the hollow outer telescoping tube 28 so as to decrease the overall axial length of the base telescoping section 16. The overall axial length of the base telescoping section 16 typically can vary from a minimum length of about 26 feet, to a maximum length of about 45+5 feet or so.

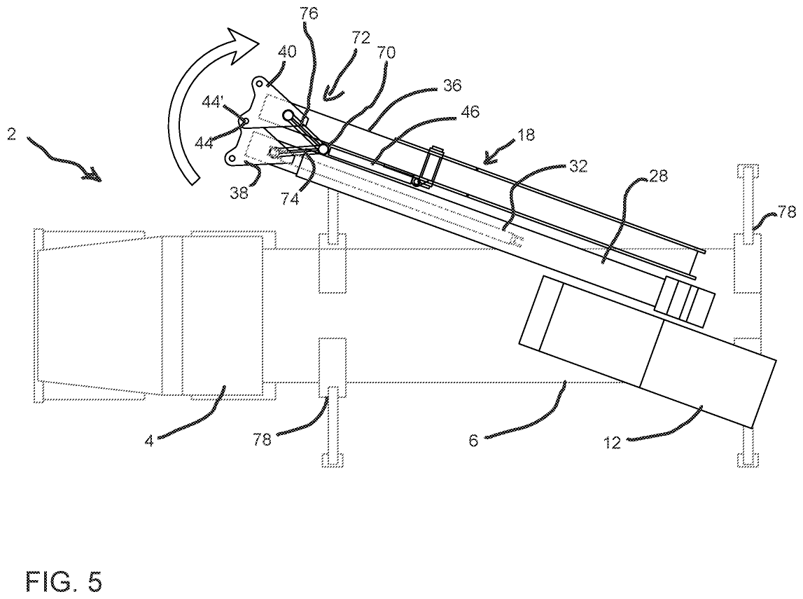

A first end of a first pivoting arm member 36, of the first pivoting arm section 18, is pivotably attached to the second end of the hollow inner telescoping tube 34 so as to facilitate a folding motion of the first pivoting arm section 18, about a lateral folding pivot axis 44′ which extends normal to the combined boom/arm pivot axis 30′ of the combined boom/arm 14, the purpose of which will become apparent from the following description. To facilitate such folding motion of the first pivoting arm section 18, about the lateral folding pivot axis, with respect to the base telescoping section 16 (as best shown in FIG. 5), a first pair of upper and lower plates 38 are permanently affixed to opposed sides of the second end of the hollow inner telescoping tube 34. A pair of axially aligned holes (not separately labeled) are formed or drilled through each of the upper and lower plates 38. In addition, the first end of the first pivoting arm member 36, of the first pivoting arm section 18, has a second pair of upper and lower plates 40 permanently affixed to opposed sides of the first end of the first pivoting arm member 36. A pair of axially aligned holes (not separately labeled) are formed or drilled through each of the upper and lower plates 40.

During assembly of the combined boom/arm 14, a second pin/bolt 44 passes through aligned holes in the first pair of the upper and lower plates 38, and also through aligned holes in the second pair of the upper and lower plates 40 in order to permanently secure to the first pivoting arm section 18 to the second end of the base telescoping section 16 of the combined boom/arm 14. The second pin/bolt 44 defines a lateral folding pivot axis 44′ for the first pivoting arm section 18. When use of the combined boom/arm 14 is desired, the first pivoting arm section 18 is axially aligned with the base telescoping section 16 of the combined boom/arm 14 (see FIG. 4A for example), the holes in the second pair of upper and lower plates 40 are axially aligned with the holes formed in each of the first pair of upper and lower plates 38. Thereafter, a first pin/bolt 42 can (manually or automatically) pass through the aligned holes in the first pair of the upper and lower plates 38, and also through the aligned holes in the second pair of the upper and lower plates 40. Such connection by the first pin/bolt 42 prevents any folding or pivoting movement of the first pivoting arm section 18 with respect to the base telescoping section 16.

However, when the first pin/bolt 42 is removed (manually or automatically) from engagement with the aligned holes of the first pair of the upper and lower plates 38 and the aligned holes of the second pair of the upper and lower plates 40, while the second pin/bolt 44 remains engaged with the aligned holes of the first pair of the upper and lower plates 38 and the aligned holes of the second pair of the upper and lower plates 40, the first pivoting arm section 18 is then able to pivot or fold, in a generally lateral or horizontal direction or plane, with respect to the base telescoping section 16, away from its axially aligned configuration, as shown in FIG. 4A, into a folded and travel configuration, as shown in FIG. 5, as discussed below in further detail. Due to the weight of the combined boom/arm 14, the folding motion generally occurs when the combined boom/arm 14 is in a horizontal position (see FIG. 4) or in a slightly raised position relative to horizontal so as to clear any obstacles or features, e.g., tail pipes, of the boom vehicle 2.

A folding piston/cylinder 46 (as best shown in FIG. 4A) is provided to facilitate such lateral or horizontal pivoting motion of the first pivoting arm section 18 from its axially aligned configuration into its lateral or horizontal folded and travel configuration, and vice versa. A first cylinder end of the folding piston/cylinder 46 is affixed to a second end of the first pivoting arm member 36, while an opposite piston end thereof is affixed adjacent to a central hub 70 of a base linkage 72 which has first and second base legs 74, 76. An opposite end of the first base leg 74 of the base linkage 72 is pivotably connected to at least one of the upper and the lower plates 38, which is permanently secured to the hollow inner telescoping tube 34, while an opposite end of the second base leg 76 of the base linkage 72 is pivotably connected to at least one of the upper and the lower plates 40, which is permanently secured to the first pivoting arm member 36. The first and second base legs 74, 76 of the base linkage 72 generally form a movable angle therebetween of about 300 to 120° or so—see FIG. 5.

When hydraulic fluid is supplied to a first end of the folding piston/cylinder 46, an overall axial length of the folding piston/cylinder 46. As the axial length of the folding piston/cylinder 46 increases, the second end of the first pivoting arm member 36 pivots or moves, about the lateral folding pivot axis 44′, laterally (and horizontally) so as to be axially aligned with the base telescoping section 16 of the combined boom/arm 14, as shown in FIG. 4A, for example. Once in this position, the first pin/bolt 42 can then be inserted (either manually by the operator or automatically by a device) into the both of the aligned holes in the upper and lower plates 38, 40 to prevent any pivoting or unfolding motion of the first pivoting arm section 18 with respect to the base telescoping section 16.

When the first pin/bolt 42 is removed from engagement with both the first pairs of aligned holes, in the upper and lower plates 38, 40 (either manually by the operator or automatically by a device which is not described in further detail), and thereafter when hydraulic fluid is supplied to an opposite second end of the folding piston/cylinder 46, the overall axial length of the folding piston/cylinder 46 thereby decreases so that the second end of the first pivoting arm member 36 of the first pivoting arm section 18 moves, pivots or folds 150°-200° preferably about 180°, about the lateral folding pivot axis 44′, so as to be located closely adjacent and parallel to the base telescoping section 16 of the combined boom/arm 14, as shown in FIG. 5. It is to be appreciated that the approximately 150°-200°, preferably about 180°, folding/unfolding motion of the first pivoting arm section 18, relative to the base telescoping section 16, occurs when both the base telescoping section 16 and the first pivoting arm section 18 are located generally in a lateral or a horizontal plane, e.g., a plane that is +10 degrees or so relative to horizontal.

A second end of the first pivoting arm member 36 is pivotably attached to a first end of a second pivoting arm member 48, of the first pivoting arm section 18, so as to facilitate changing the vertical orientation of the second pivoting arm member 48 with respect to the first pivoting arm member 36. To achieve such pivoting motion of the second pivoting arm member 48 with respect to the first positing arm member, an upper portion of the second end of the first pivoting arm member 36 is pivotably connected to an upper portion of the first end of the second pivoting arm member 48 by a pivoting arm member pin/bolt 50. The arm member pin/bolt 50 defines a pivoting arm member pivot axis 50′ about which the first pivoting arm section 18 pivots.

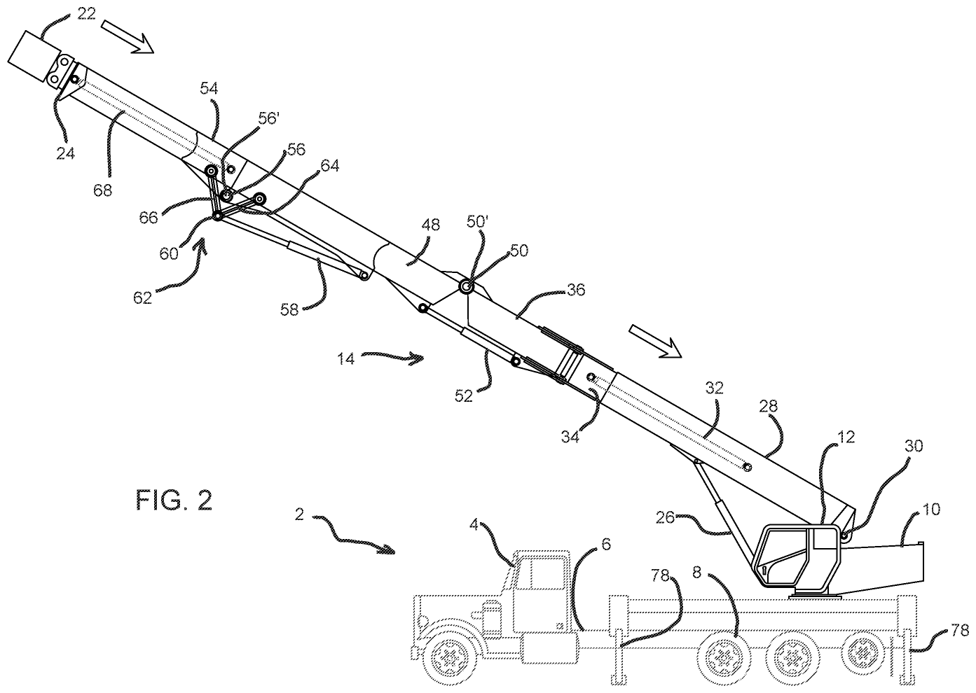

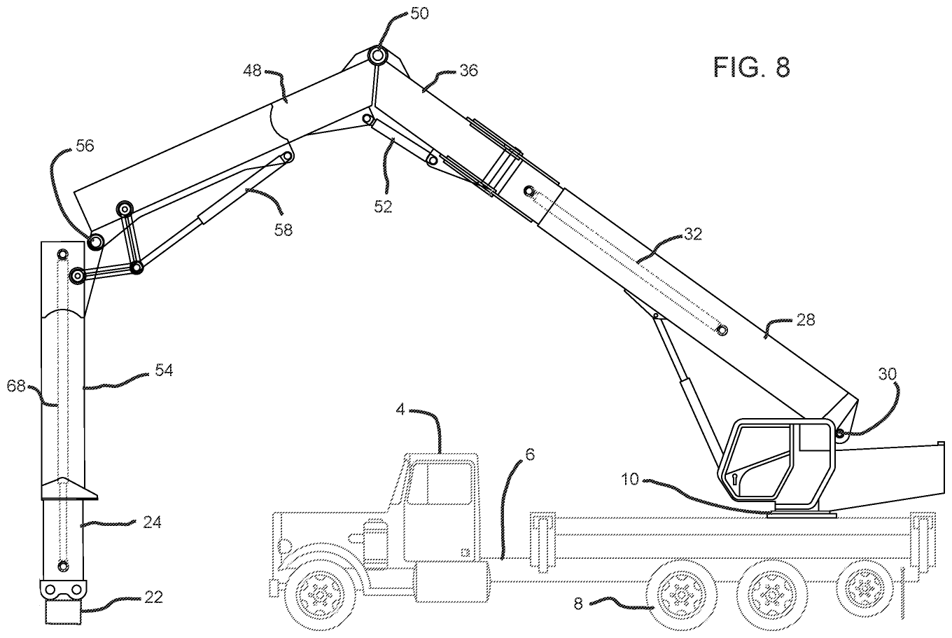

A pivoting arm piston/cylinder 52 is provided to facilitate pivoting motion of the first pivoting arm section 18 from its axially aligned configuration (see FIG. 1 for example) into a desired angled position (see FIG. 8), and vice versa. A first cylinder end of the pivoting arm piston/cylinder 52 is affixed to flange secured to an exterior surface of the first pivoting arm member 36 while an opposite piston end thereof is affixed to a flange secured to the first end of the second pivoting arm member 48. When hydraulic fluid is supplied to a first end of the pivoting arm piston/cylinder 52, an overall axial length of the pivoting arm piston/cylinder 52 increases so that the second end of the second pivoting arm member 48 moves and pivots, about the pivoting arm member pivot axis 50′, so as to be substantially axially aligned with the first pivoting arm member 36 (see FIGS. 1 and 2 for example). Alternatively, when hydraulic fluid is supplied to an opposite second end of the pivoting arm piston/cylinder 52, the overall axial length of the pivoting arm piston/cylinder 52 thereby decreases so that the second end of the second pivoting arm member 48 moves and pivots, about the pivoting arm member pivot axis 50′, away from its axially aligned configuration into a desired angled configuration, an example of which is shown in FIG. 8, so as to form an angle with the first pivoting arm member 36. It is to be appreciated that the pivoting arm piston/cylinder 52 is able to pivot the second pivoting arm member 48 relative to the first pivoting arm member 36 about an angle of 45°-90° or so.

A first end of an outer implement telescoping tube 54, of the implement telescoping section 20, is pivotably attached to the second end of the second pivoting arm member 48 so as to facilitate changing the orientation of the implement telescoping section 20 with respect to the second pivoting arm member 48. To achieve such pivoting motion of the implement telescoping section 20 with respect to the second pivoting arm member 48, a lower flange portion of the second end of the second pivoting arm member 48 is pivotably connected to a lower flange portion, of the first end of the outer implement telescoping tube 54, by an implement arm pin/bolt 56. The implement arm pin/bolt 56 defines an implement arm pivot axis 56′ about which the implement telescoping section 20 pivots.

An implement piston/cylinder 58 is provided to facilitate pivoting of the implement telescoping section 20 from its axially aligned configuration into a partially or a completely folded and travel configuration, and vice versa. A first cylinder end of the implement piston/cylinder 58 is pivotably connected to a flange supported on the exterior surface of the second pivoting arm member 48 while an opposite piston end thereof is pivotably connected to a central hub 60 of an implement linkage 62 which has first and second implement legs 64, 66. An opposite end of the first implement leg 64 of the implement linkage 62 is pivotably connected to a flange secured to the second end of the second pivoting arm member 48 while an opposite end of the second implement leg 66 of the implement linkage 62 is pivotably connected to a flange secured to the first end of the outer implement telescoping tube 54. The first and second implement legs 64, 66 of the implement linkage 62 generally form a movable angle therebetween of about 300 to 1300 or so.

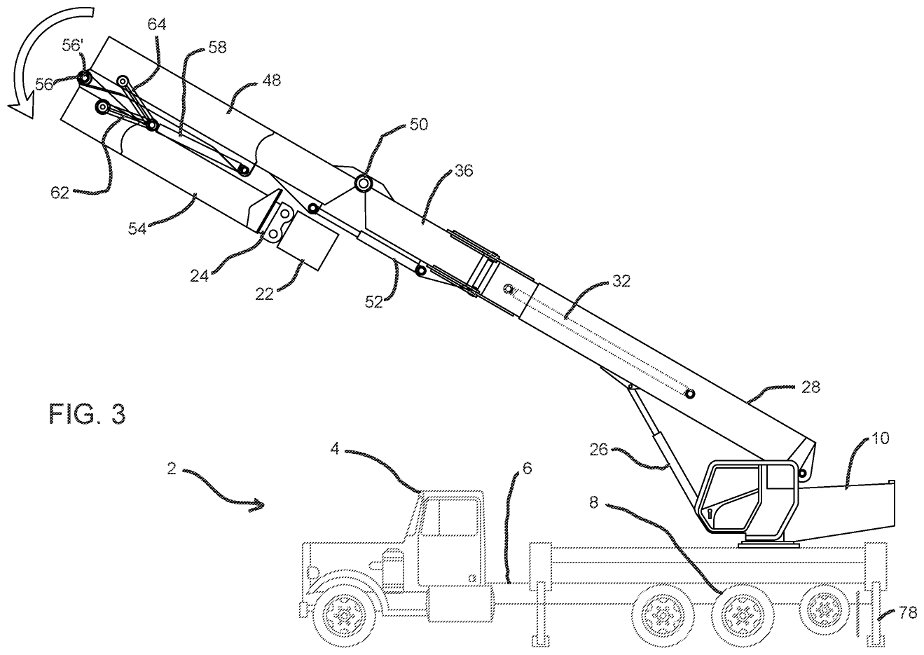

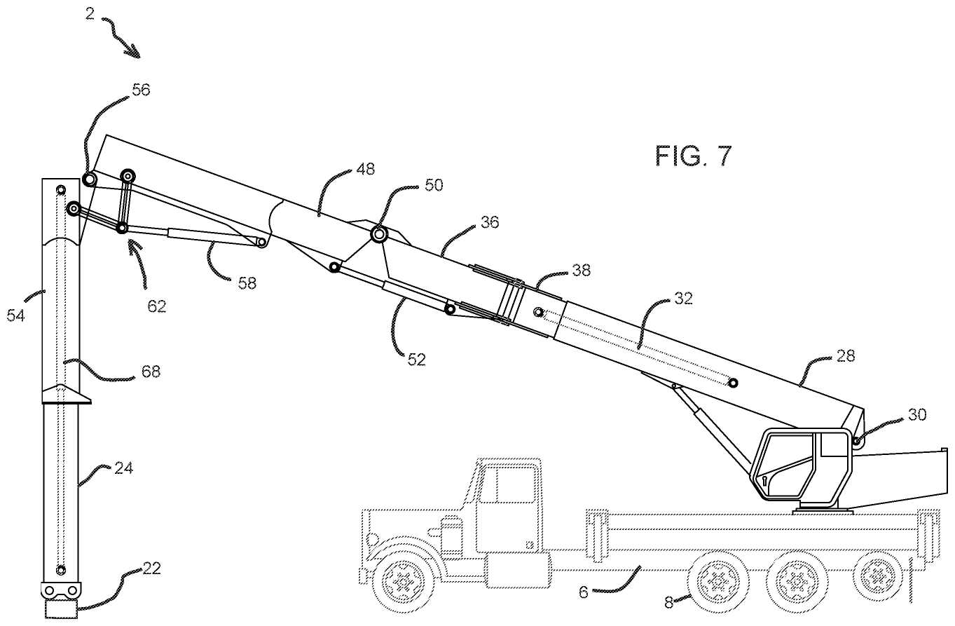

When hydraulic fluid is supplied to a first end of the implement piston/cylinder 58, an overall axial length of the implement piston/cylinder 58 increases so that the second end of the outer implement telescoping tube 54 pivots, about the implement arm pivot axis 56′, so as to be axially aligned with the second pivoting arm member 48, as generally shown in FIG. 1 or 2. Alternatively, when hydraulic fluid is supplied to an opposite second end of the implement piston/cylinder 58, the overall axial length of the implement piston/cylinder 58 thereby decreases so that the second end of the outer implement telescoping tube 54 pivots away from its axially aligned configuration into either a partially folded configuration, as shown in FIG. 7, or a completely folded and travel configuration, as shown in FIG. 3, in which the outer implement telescoping tube 54 is located closely adjacent and extends substantially parallel to the second pivoting arm member 48. That is, the folding of implement telescoping section 20, relative to the second pivoting arm member 48, generally occurs in a vertical plane.

It is to be appreciated that implement piston/cylinder 58 in combination with the implement linkage 62 is able to pivot the implement telescoping section 20, relative to the second pivoting arm member 48, over an angle of about 150°-200°, preferably about 180°, or so from an axially aligned configuration, in which the implement telescoping section 20 is axially aligned with the second pivoting arm member 48, into a completely folded position, in which the implement telescoping section 20 is pivoted substantially 150°-200°, preferably about 180°, relative to the second pivoting arm member 48, into a folded position in which the implement telescoping section 20 is located closely adjacent and extends substantially parallel to, but is located vertically below, the second pivoting arm member 48 (see FIG. 3).

An implement telescoping piston/cylinder 68 is provided for extending and retracting the position of the hollow inner implement telescoping tube 24 relative to the hollow outer implement telescoping tube 54. As shown, a first cylinder end of the implement telescoping piston/cylinder 68 is affixed to a (interior) surface of the outer implement telescoping tube 54 while an opposite piston end thereof is affixed adjacent to a second end of the inner implement telescoping tube 24. When hydraulic fluid is supplied to a first end of the implement telescoping piston/cylinder 68, an overall axial length of the implement telescoping piston/cylinder 68 increases so that the second end of the inner implement telescoping tube 24 slides and moves away from the second end of the outer implement telescoping tube 54 thereby to increase the overall length of implement telescoping section 20.

Alternatively, when hydraulic fluid is supplied to an opposite second end of the implement telescoping piston/cylinder 68, the overall axial length of the implement telescoping piston/cylinder 68 thereby decreases so that the second end of the inner implement telescoping tube 24 slides and moves toward the second end of the outer implement telescoping tube 54 thereby to decrease the overall axial length of implement telescoping section 20 of the combined boom/arm 14. The overall axial length of the implement telescoping section 20, of the combined boom/arm 14, typically can vary from a minimum length of about 14 feet or so, to a maximum length of about 24 feet or so.

A desired implement 22 is releasable attached to the second end of the inner implement telescoping tube 24 to facilitate, if desired, replacement thereof with another implement. As noted above, the implement 22 may be, for example, a conventional grappler device (with or without an integrated chain saw) or a concrete pulverizing device, etc. Preferably, the desired implement 22 is rotationally affixed to the second end of the implement telescoping section 20 to allow rotation of the implement 22, relative to the inner implement telescoping tube 24 during use. In addition, the desired implement 22 is also preferably pivotably affixed to the second end of the inner implement telescoping tube 24 to allow up and down and/or side to side pivoting movement of the desired implement 22 with respect to the inner implement telescoping tube 24. As such rotational and pivotable connection of the desired implement 22, to the second end of the inner implement telescoping tube 24 is conventional and well known in the art, a further detailed discussion concerning the same is not provided.

As shown in FIGS. 1-8 for example, the boom vehicle 2 is equipped with a number of deployable/retractable outriggers 78, e.g., preferable two pairs of spaced apart outriggers 78 located along each side of the boom vehicle 2. As is conventional in the art, once these outriggers 78 are deployed, they assist with stabilizing the boom vehicle 2 during operation thereof. As such deployable/retractable outriggers 78 are conventional and well known in the art, a further detailed discussion concerning the same is not provided.

It is to be appreciated that both the pivoting arm member pivot axis 50′ and the implement arm pivot axis 56′ extend generally parallel to one another. In addition, the lateral folding pivot axis 44′ extends substantially normal to be the pivoting arm member pivot axis 50′, the implement arm pivot axis 56′ and the combined boom/arm pivot axis 30′.

When the combined boom/arm 14 in its completely folded and stored configuration to facilitate travel of the boom vehicle position (see FIG. 6), the implement arm pivot axis 56′ and the combined boom/arm pivot axis 30′ are located closely adjacent to and extend parallel to one another. The lateral folding pivot axis 44′ is located adjacent the vehicle cab 4 and spaced from both the implement arm pivot axis 56′ and the combined boom/arm pivot axis 30′ and the lateral folding pivot axis 44′ extends normal to the axes of both the implement arm pivot axis 56′ and the combined boom/arm pivot axis 30′. This is, the implement telescoping section 20 is located vertically underneath, closely adjacent to and extends generally parallel to the first pivoting arm section 18, i.e., the implement telescoping section 20 and the first pivoting arm section 18 both lie in a vertically plane. The first pivoting arm section 18 is located closely adjacent, laterally/horizontally offset and extends generally parallel to the base telescoping section 16, i.e., the first pivoting arm section 18 and the base telescoping section 16 both lie in a horizontal plane. The first pivoting arm section 18 is the only section which lies in both of those planes.

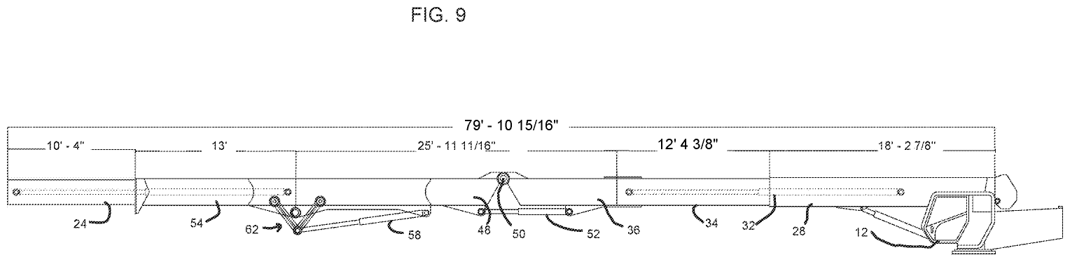

As shown in FIGS. 9-11, the outer telescoping tube 28 typically has a length of about 26 feet or so, the inner telescoping tube 34 typically has an extended length of about 18 feet or so, the first and second pivoting arm members 36, 48 typically have a combined length of about 45 feet or so, and the outer implement telescoping tube 54 typically has a length of about 13 feet or so while the inner implement telescoping tube 24 typically has an extended length of about 10 feet or so. The total overall axial length of the combined boom/arm 14 is approximately 80 feet. As a result of such arrangement, the combined boom/arm 14 is able to reach a distance of about 67 feet or so away from the rotational axis of the boom/cab framework 10 and is also able to reach a height of about 40 feet or so above a surface supporting the boom vehicle 2.

Folding the Combined Boom/Arm for Transport

Assuming that the combined boom/arm 14 is in the configuration shown in FIG. 1, for example, and a desired job has been completed at the work site. The operator will then manipulate and collapse the combined boom/arm 14 so as to store the same on the boom vehicle 2 for transport, as generally shown in FIG. 6. In order to achieve this, during a first step, hydraulic fluid is supplied to an opposite second end of the implement telescoping piston/cylinder 68 so as to decrease the overall axial length of the implement telescoping piston/cylinder 68. This causes the second end of the inner implement telescoping tube 24 to move toward the second end of the outer implement telescoping tube 54 and thereby reduce the length of the implement telescoping section 20 to its small axial length, as generally shown in FIG. 2.

As also shown in FIG. 2, hydraulic fluid is supplied to an opposite second end of the base telescoping piston/cylinder 32 to move the second end of the hollow inner telescoping tube 34 toward the second end of the hollow outer telescoping tube 28 and thereby minimize the overall axial length of the base telescoping section 16. It is to be appreciated that such decrease in the overall axial length of the base telescoping section 16 can occur either before, during or after reducing the length of the implement telescoping section 20. FIG. 2 shows both the implement telescoping section 20 and the base telescoping section 16 in their fully collapsed configurations so as to each have a minimal axial length.

Next, during a second step, hydraulic fluid is supplied to the opposite second end of the implement piston/cylinder 58 so that the overall axial length of the implement piston/cylinder 58 decreases. As this occurs, the second end of the implement telescoping section 20 pivots away from its axially aligned configuration, about the implement arm pivot axis 56′—in a generally in a vertical plane—into its completely folded and travel configuration, as shown in FIG. 3. In such completely folded and travel configuration, the outer implement telescoping tube 54 is located closely adjacent to and extends substantially parallel to the second pivoting arm member 48, and is located vertically below the second pivoting arm member 48.

After this occurs, during a third step, the boom piston/cylinder 26 is then manipulated so as to lower the combined boom/arm 14, about the combined boom/arm pivot axis 30′, into a substantially horizontal configuration (see FIG. 4) in which the combined boom/arm 14 extends generally parallel to the ground or other surface upon which the boom vehicle 2 is located.

Once the combined boom/arm 14 is located generally parallel to the ground or other surface, the first pin/bolt 42 is then (manually or automatically) removed from engagement with the aligned holes in both pairs of the upper and lower plates 38, 40, while the second pin/bolt 44 still remains permanently engaged with the aligned holes in both pairs of the upper and lower plates 38, 40. After the first pin/bolt 42 is removed, then the first pivoting arm section 18 is able to pivot or fold, in a generally lateral or horizontal direction, and be repositioned horizontally offset with respect to the base telescoping section 16. To achieve this, during a fourth step, hydraulic fluid is then supplied to an opposite second end of the folding piston/cylinder 46 so that the overall axial length of the folding piston/cylinder 46 thereby decreases. As this occurs, the first pivoting arm member 36 of the first pivoting arm section 18 moves or pivots, about the lateral folding pivot axis 44′, so as to laterally and/or horizontally fold and thus be located closely adjacent and parallel to the base telescoping section 16 of the combined boom/arm 14, as shown in FIG. 5.

Lastly, during a fifth step, the boom/cab framework 10 is rotated, relative to the vehicle framework 6 so that the combined boom/arm 14 is thereafter located in the storage and transport position, as generally shown in FIGS. 6 and 6A. With the combined boom/arm 14 in such configuration, the combined boom/arm 14 is sufficiently compact so that the boom vehicle 2 can safely and legally travel along a desired public roadway or highway. That is, the boom vehicle 2, with the folded combined boom/arm 14, as shown in FIGS. 6 and 6A, has a height no greater than 13 feet, 6 inches and a width no greater than 8 feet 6 inches. Prior to travel, each one of the outriggers 78 is moved into is retracted position, to permit travel of the boom vehicle 2

When use of the combined boom/arm 14 is desired, after the boom vehicle arrives at the desired site, the above process is merely reversed to deploy the outriggers 78 and thereafter unfold the combined boom/arm 14 into its use configuration.

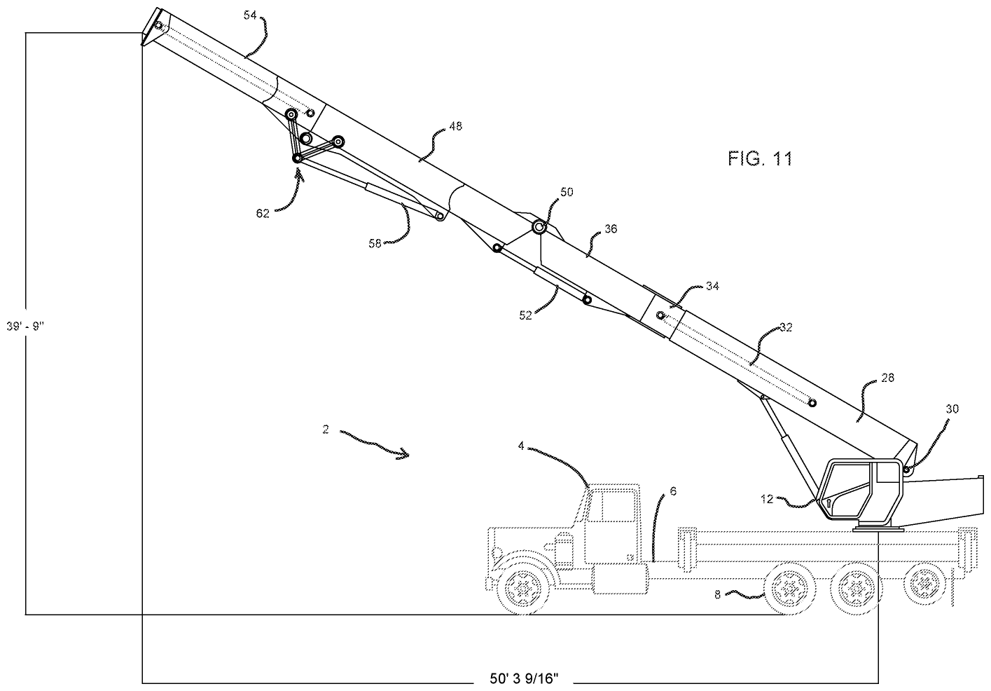

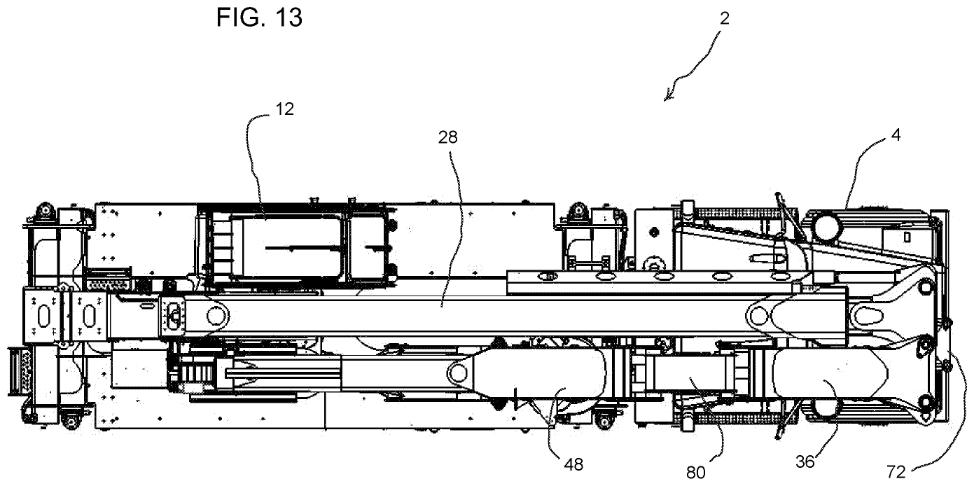

Turning now to FIGS. 11-23B, a second embodiment of the present invention will now be described. As this embodiment is very similar to the previously discussed embodiment, identical elements will be given identical reference numerals.

This embodiment, as with the previous embodiment, relates to a boom vehicle 2 which has a conventional vehicle cab 4, for accommodating at least a vehicle operator during transport of the boom vehicle 2 from one site or location to another site or location over a road or a highway. The boom vehicle 2 also includes a vehicle framework 6 that supports a plurality of wheels 8 which are driven, in a conventional manner, by an engine (not shown) to facilitate movement of the boom vehicle 2 over a roadway or some other desired surface. A boom/cab framework 10 is rotatably supported by the vehicle framework 6, in a conventional manner, so that the boom/cab framework 10 can rotate, relative to the vehicle framework 6, during operation thereof. A boom cab 12 is supported by and rotates or moves with the boom cab framework 10. As such rotation of the boom/cab framework 10 relative to the vehicle framework 6 is conventional and well known in the art, a further detailed discussion concerning the same is not provided.

The combined boom/arm 14 is supported by the rotatable boom/cab framework 10 so as to move therewith. The combined boom/arm 14 generally comprises at least four boom sections, namely, a base telescoping section 16, a first pivoting arm section 18, a second pivoting section 24 and an implement manipulating section 20. A desired implement 22, such as a conventional grappler device, (with or without an integrated chain saw), a mobile chipper, a concrete pulverizing device, etc., (only diagrammatically shown in the Figures, for example) is affixed, in a conventional manner, to a free end of the implement manipulating section 20 by a 360° hydraulic rotatable coupling 94 or a 360° hydraulic worm gear so that the attached implement 22 is able to rotate relative to the second end of a free end of the implement manipulating section 20. The desired implement 22 may either be permanently affixed to the free end of the implement manipulating section 20 or may be releasably connected thereto by a convention quick connect mechanism. A further detailed description concerning each of these components will now be provided.

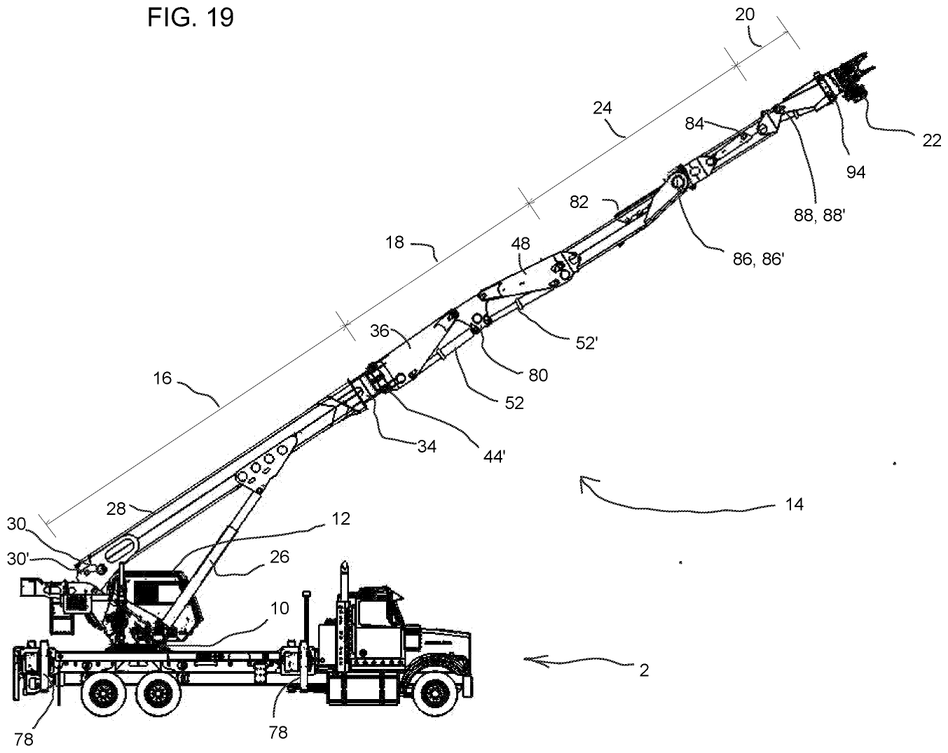

As diagrammatically shown, the boom/cab framework 10 is generally rotatably pivotally supported by the vehicle framework 6. That is, the boom/cab framework 10, which supports both the boom cab 12 and the combined boom/arm 14, is able to rotate in a conventional manner by a hydraulic motor, for example (not shown in detail) relative to the vehicle framework 6 of the boom vehicle 2 over an angle of at least 90°, either toward the left of the vehicle 2 or toward the right of the vehicle 2, from a central position shown in FIG. 19, for example. Typically, the boom/cab framework 10 is able to rotate, relative to the vehicle framework 6, over an angle of 360°. In addition, the boom cab 12 is provided with internal controls (not shown) for controlling operation of the combined boom/arm 14 as well as the supported implement 22, e.g., the internal controls facilitate raising and lowering the combined boom/arm 14, extending and retracting of the combined boom/arm 14, folding/unfolding of the combined boom/arm 14, operating, manipulating, rotating and/or pivoting of the supported implement 22, etc. As such rotation of the boom cab 12, relative to the vehicle framework 6, as well as operation of the supported implement 22 by the internal controls is conventional and fairly well known in the art, a further discussion concerning those components and features is not provided.

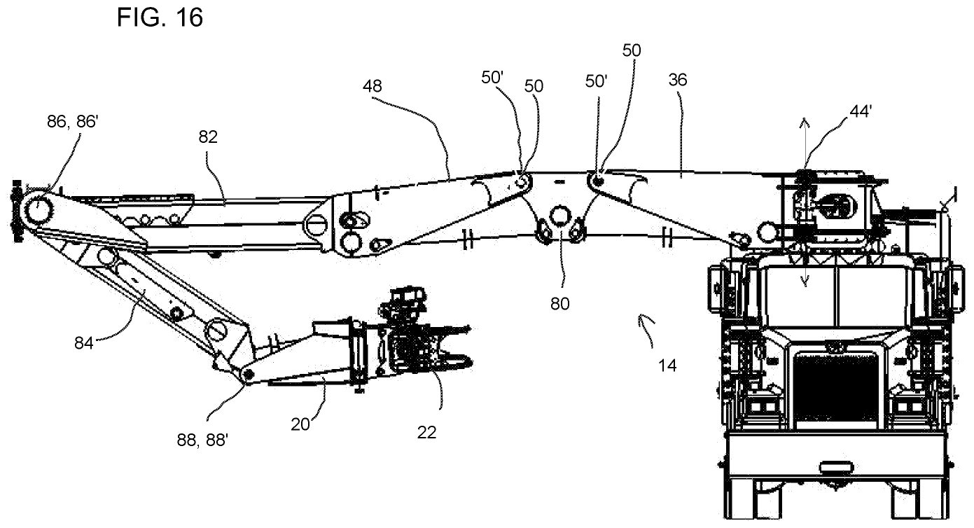

A boom piston/cylinder 26 is provided for adjusting, e.g., raising and lowering, the position of the combined boom/arm 14, as well as the supported implement 22, relative to the boom/cab framework 10. A first end of the hollow outer telescoping tube 28 is pivotably connected to the boom/cab framework 10 by a combined boom/arm pin/bolt 30, for example. The combined boom/arm pin/bolt 30 defines a combined boom/arm pivot axis 30′ about which the entire combined boom/arm 14 pivots, about a generally horizontal pivot axis, with respect to the boom/cab framework 10. As shown, a first cylinder end of the boom piston/cylinder 26 is pivotably affixed to a portion of the boom/cab framework 10, while an opposite piston end thereof is affixed to an intermediate section of the hollow outer telescoping tube 28 of the base telescoping section 16. When hydraulic fluid is supplied to a first end of the boom piston/cylinder 26, an overall axial length of the boom piston/cylinder 26 increases so that a second end of the hollow outer telescoping tube 28 (along with a remainder of the combined boom/arm 14) is pivoted, about the combined boom/arm pivot axis 30′, upwardly relative to and away from the boom/cab framework 10 and the ground, e.g., from the position shown in FIG. 17 to the position shown in FIG. 19, for example.

Alternatively, when hydraulic fluid is supplied to an opposite second end of the boom piston/cylinder 26, the overall axial length of the boom piston/cylinder 26 thereby decreases so that the second end of the hollow outer telescoping tube 28 pivots (along with a remainder of the combined boom/arm 14), about the combined boom/arm pivot axis 30′, downwardly relative to and toward the boom/cab framework 10 and the ground, e.g., from the position shown in FIG. 19 to the position shown in FIG. 17, for example. The boom piston/cylinder 26 is generally able to manipulate or pivot the hollow outer telescoping tube 28, as well as the remainder of the combined boom/arm 14, relative to the boom/cab framework 10 and the ground, about an angle of 70°±20° or so from a generally horizontal position, as shown in FIG. 17 for example, into a variety of different elevated positions, as shown in FIGS. 19-22, for example.

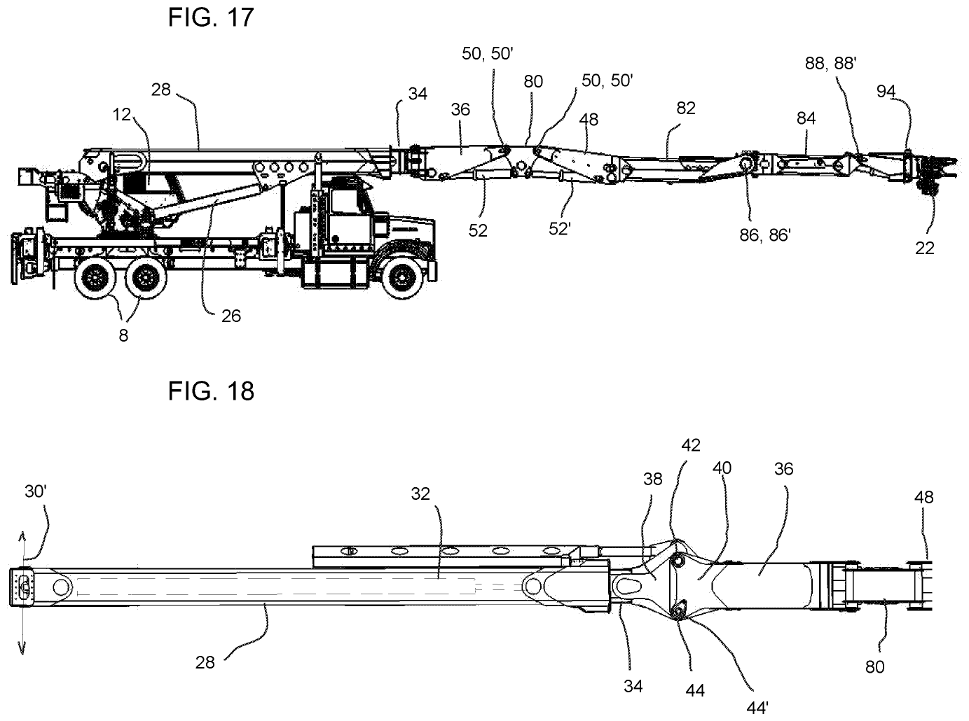

An internal base telescoping piston/cylinder 32 (see FIG. 18) is provided for extending and retracting the position of the hollow inner telescoping tube 34 relative to the hollow outer telescoping tube 28. As diagrammatically shown, a first cylinder end of the base telescoping piston/cylinder 32 is affixed to an interior surface of the hollow outer telescoping tube 28, adjacent the first end thereof, while an opposite piston end thereof is affixed adjacent to a second end of the hollow inner telescoping tube 34. When hydraulic fluid is supplied to a first end of the base telescoping piston/cylinder 32, an overall axial length of the base telescoping piston/cylinder 32 increases so as to cause the second end of the hollow inner telescoping tube 34 to gradually move away from the second end of the hollow outer telescoping tube 28 and thereby increase the overall axial length of the base telescoping section 16.

Alternatively, when hydraulic fluid is supplied to an opposite second end of the base telescoping piston/cylinder 32, the overall axial length of the base telescoping piston/cylinder thereby gradually decreases so that the second end of the hollow inner telescoping tube 34 is gradually retracted and moves toward the second end of the hollow outer telescoping tube 28 and thereby decreases the overall axial length of the base telescoping section 16. The overall axial length of the base telescoping section 16, of the combined boom/arm 14, typically can vary from a minimum length of about 28 feet, to a maximum length of about 44±5 feet or so.

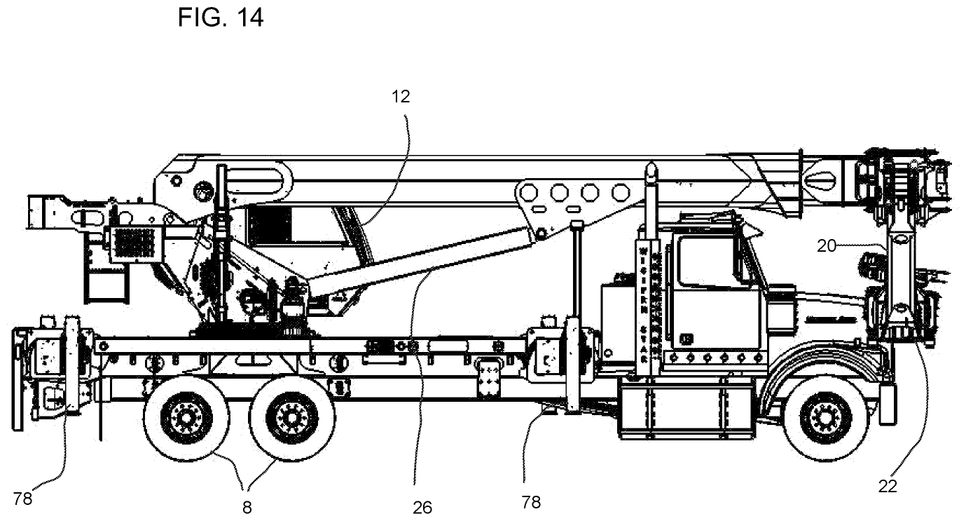

A first end of a first pivoting arm member 36, of the first pivoting arm section 18, is pivotably attached to the second end of the hollow inner telescoping tube 34 so as to facilitate both a folding motion and an unfolding motion of the pivoting arm section 18, about a lateral folding pivot axis 44′ which extends normal to the combined boom/arm pivot axis 30′ of the combined boom/arm 14. To facilitate such folding motion of the pivoting arm section 18, about the lateral folding pivot axis 44′, with respect to the base telescoping section 16 (see FIG. 15 for example), a first pair of upper and lower plates 38 are permanently affixed to opposed upper and lower sides of the second end of the hollow inner telescoping tube 34. A pair of spaced apart and axially aligned holes (not separately labeled) are formed or drilled through each of the first upper and lower plates 38. The first end of the first pivoting arm member 36, of the pivoting arm section 18, has a second pair of upper and lower plates 40 permanently affixed to opposed upper and lower sides of the first end of the first pivoting arm member 36. A pair of spaced apart and axially aligned holes (not separately labeled) are formed or drilled through each of the second upper and lower plates 40. First pair of upper and lower plates 38 are arranged to overlap the second pair of upper and lower plates 40, or vice versa, so as to permit the holes to align with one another and facilitate connection.

During initial assembly of the combined boom/arm 14, a second pin/bolt 44 passes through the aligned holes in the first pair of the upper and lower plates 38, and also passes through the aligned holes in the second pair of the upper and lower plates 40 in order to permanently secure to the pivoting arm section 18 to the second end of the base telescoping section 16. Once the second pin/bolt 44 is installed, the second pin/bolt 44 is not intended to be removed. The second pin/bolt 44 permits relative rotation between the pivoting arm section 18 and the base telescoping section 16 and defines the lateral folding pivot axis 44′ for the pivoting arm section 18.

When the combined boom/arm 14 is unfolded into its operational position, the pivoting arm section 18 is axially aligned with the base telescoping section 16 of the combined boom/arm 14 (see FIGS. 17 and 18 for example), and the holes in the second pair of upper and lower plates 40 are axially aligned with the holes formed in the first pair of upper and lower plates 38. Thereafter, either an operator can manual insert a pin/bolt 42 through the aligned holes in the overlapped first and second upper and lower plates 38, 40 or a hydraulically actuated first pin/bolt 42 can be actuated, by a first pin hydraulic cylinder, to extend and pass a leading end of the hydraulically actuated first pin/bolt 42 through the aligned holes in the overlapped first and second upper plates 38, 40, while a hydraulically actuated second pin/bolt 42 can be actuated, by a second pin hydraulic cylinder, to extend and pass a leading end of the hydraulically actuated second pin/bolt 42 through the aligned holes in the overlapped first and second lower plates 38, 40. Such connection by either manual insertion of the pin/bolt 42 through the aligned holes or the actuation of the hydraulically actuated first and second pins/bolts 42 thereby connects the pivoting arm section 18 to the base telescoping section 16 and prevents any undesired folding or pivoting movement of the pivoting arm section 18 with respect to the base telescoping section 16.

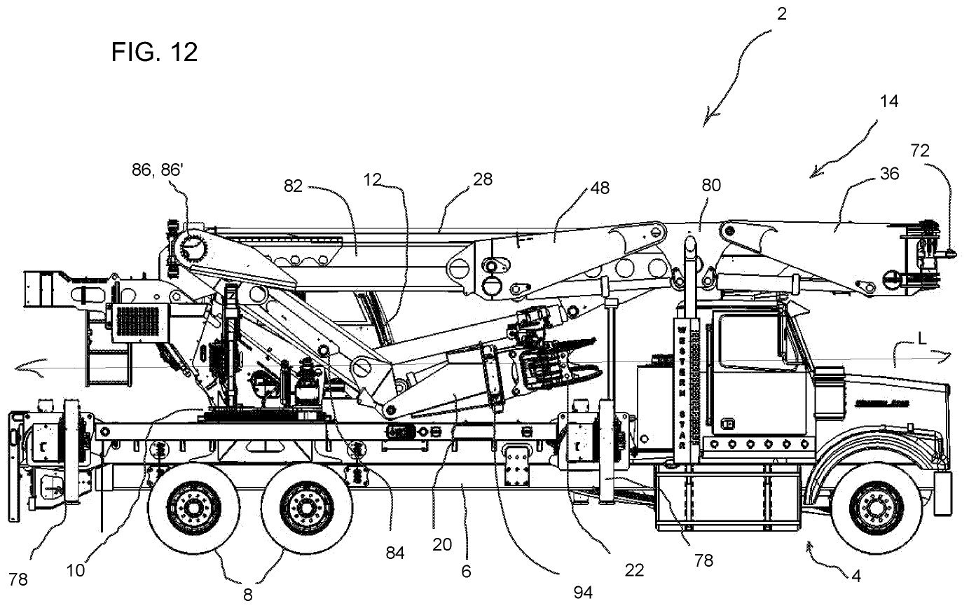

However, when an operator manually withdraws or removes the pin/bolt 42 from the aligned holes or the hydraulically actuated first and second pins/bolts 42 are withdrawn and disengaged, by the first and second pin hydraulic cylinders respectively, from the aligned holes of the first and second upper and lower plates 38. 40, while the second pin/bolt 44 still remains permanently engaged with the aligned holes of the upper and lower plates 38, 40, the pivoting arm section 18 is partially decoupled from the base telescoping section 16. As a result, the pivoting arm section 18 is then free to pivot or fold, in a generally lateral or horizontal direction or plane, with respect to the base telescoping section 16, away from its axially aligned configuration, as shown in FIGS. 17 and 18, into a folded configuration, as shown in FIGS. 11 and 12, to facilitate storage and transport of the boom vehicle 2.

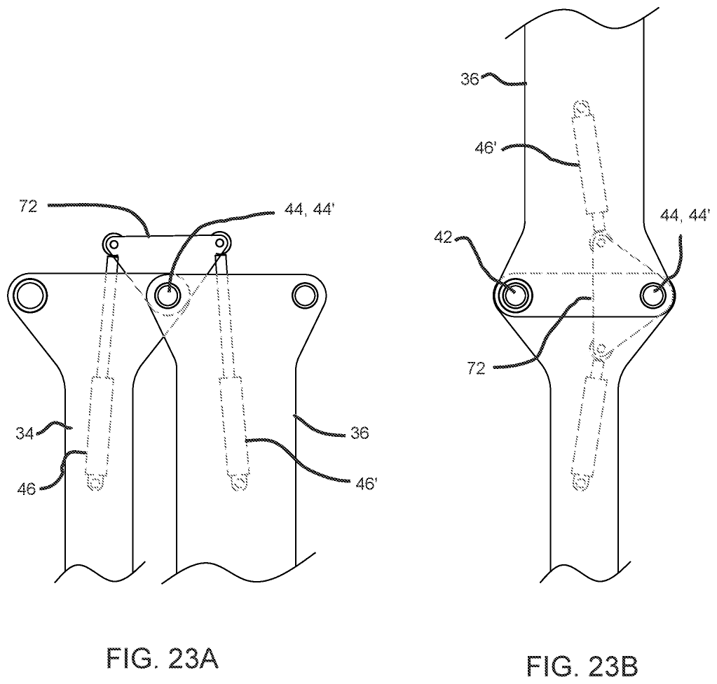

Somewhat different from the prior embodiment, first and second folding pistons/cylinders 46, 46′ (as best shown diagrammatically in FIGS. 23A and 23B) are provided to facilitate such lateral or horizontal pivoting motion of the pivoting arm section 18 from its folded and travel configuration into its operational axially aligned configuration, and vice versa. A first cylinder end of the first folding piston/cylinder 46 is affixed to an interior section of the hollow inner telescoping tube 34 (only diagrammatically shown) while an opposite piston end thereof is affixed to a first end of a generally triangular shaped pivoting linkage 72. A first cylinder end of the second folding piston/cylinder 46′ is affixed to an interior section of the first pivoting arm member 36, while an opposite piston end thereof is affixed to a second side of the pivoting linkage 72. A third side of the pivoting linkage 72 is pivotably connected to and supported by the second pin/bolt 44 so as to be rotatable about the lateral folding pivot axis 44′.

When hydraulic fluid is supplied to a first ends of the first and the second folding pistons/cylinders 46, 46′, the overall axial lengths of the first and the second folding pistons/cylinders 46, 46′ decrease. As the axial lengths of the first and the second folding pistons/cylinders 46, 46′ decrease, the second end of the first pivoting arm member 36 gradually pivots or moves laterally, about the lateral folding pivot axis 44′, from the position shown in FIG. 23A toward the position shown in FIG. 23B, i.e., toward axial alignment with the base telescoping section 16 of the combined boom/arm 14 as shown in FIGS. 17 and 18. After the first pivoting arm member 36 is sufficiently rotated so as to become axially aligned with the base telescoping section 16, either the operator manually inserts the pin/bolt 42 into the aligned holes or the hydraulically actuated first pin/bolt 42 is actuated in a locking direction, by the first pin hydraulic cylinder, to extend and pass the leading end of the hydraulically actuated first pin/bolt 42 through the aligned holes in the first and second upper plates 38, 40 while, generally at the same time, the hydraulically actuated second pin/bolt 42 is also actuated in a locking direction, by the second pin hydraulic cylinder, to extend and pass the leading end of the hydraulically actuated second pin/bolt 42 through the aligned holes in the first and second lower plates 38, 40 to connect the first pivoting arm member 36 to the base telescoping section 16 and, thereafter, prevent pivoting or unfolding motion of the first pivoting arm section 18 with respect to the base telescoping section 16.

When storage and/or transport of the combined boom/arm 14 is desired, either the operator manually withdraws or removes the pin/bolt 42 from the aligned holes or the hydraulically actuated first pin/bolt 42 is actuated in an opposite retracting direction, by the first pin hydraulic cylinder, to retract and withdraw the hydraulically actuated first pin/bolt 42 from the aligned holes in the first and second upper plates 38, 40 while, generally at the same time, the hydraulically actuated second pin/bolt 42 is also actuated in an opposite retracting direction, by the second pin hydraulic cylinder, to retract and withdraw the hydraulically actuated second pin/bolt 42 from the aligned holes in the first and second lower plates 38, 40 to thereby partially disconnect the first pivoting arm member 36 from to the base telescoping section 16 and, thereafter, permit the desired pivoting or folding motion of the first pivoting arm section 18 relative to the base telescoping section 16 while the second pin/bolt 44 still remains permanently engaged with the aligned holes of the upper and lower plates 38, 40.

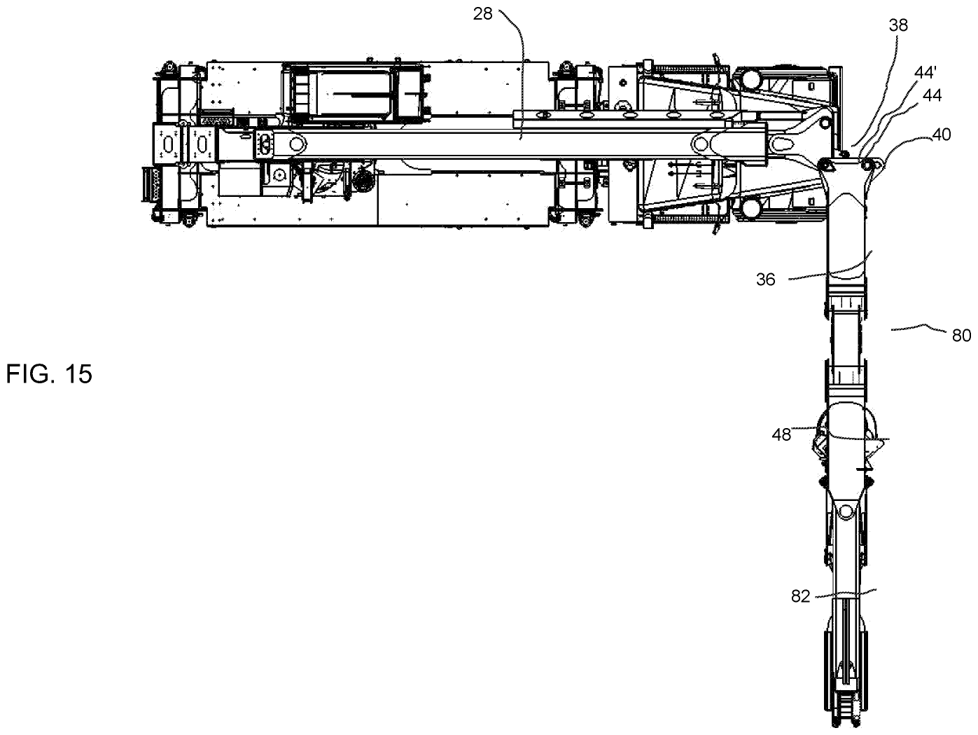

Once the first pivoting arm member 36 is partially disconnected from the base telescoping section 16, then hydraulic fluid is supplied to an opposite second end of each of the first and the second folding pistons/cylinders 46, 46′. As this occurs, the overall axial lengths of the first and the second folding pistons/cylinders 46, 46′ thereby increase so that the second end of the first pivoting arm member 36, of the first pivoting arm section 18, gradually moves, pivots or folds 150°-200°, preferably about 180°, about the lateral folding pivot axis 44′, so as to be located closely adjacent and extend parallel to the base telescoping section 16 of the combined boom/arm 14, as shown in FIGS. 12, 13 and 23A. It is to be appreciated that the approximately 150°-200°, preferably about 180°, folding/unfolding motion, of the first pivoting arm section 18 relative to the base telescoping section 16, generally occurs only when both the base telescoping section 16 and the first pivoting arm section 18 are located generally in a horizontal plane, e.g., a plane that is 0° to 10° or so relative to horizontal, as shown in FIGS. 16 and 17 for example.

A second end of the first pivoting arm member 36 is pivotably attached, by a first pivoting arm member pin/bolt 50, to first end of an arm coupling linkage 80 while a first end of a second pivoting arm member 48, of the first pivoting arm section 18, is pivotably attached, by a second pivoting arm member pin/bolt 50, to second end of the arm coupling linkage 80. The first arm member pin/bolt 50 defines a pivoting arm member pivot axis 50′ about which the arm coupling linkage 80 and the second pivoting arm member 48 can pivot with respect to the first pivoting arm member 36. The second arm member pin/bolt 50 defines a pivoting arm member pivot axis 50′ about which the arm coupling linkage 80 and the first pivoting arm member 36 can pivot with respect to the second pivoting arm member 48 over an angle of about 45° to 100°, typically about 70°.

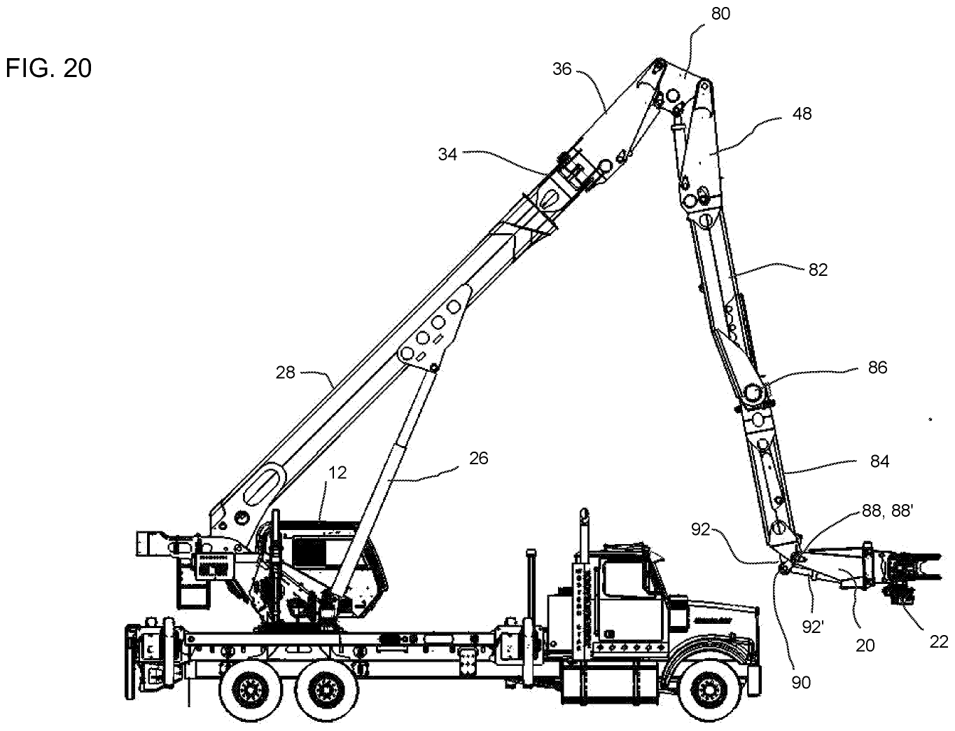

At least one and preferably a pair of side by side first pivoting arm piston(s)/cylinder(s) 52 is/are provided to facilitate pivoting motion of the arm coupling linkage 80 and the second pivoting arm member 48 with respect to the first pivoting arm member 36 to a desired angled position (see FIGS. 20-22). A first cylinder end of each first pivoting arm piston/cylinder 52 is affixed to a surface of the first pivoting arm member 36 while an opposite piston end thereof is affixed to the arm coupling linkage 80. When hydraulic fluid is supplied to a first end of each first pivoting arm piston/cylinder 52, an overall axial length of the first pivoting arm piston/cylinder 52 increases so that the arm coupling linkage 80 and the second end of the second pivoting arm member 48 together move and pivot, about the first pivoting arm member pivot axis 50′, toward a substantially axially aligned configuration with the first pivoting arm member 36 (see FIG. 19, for example). Alternatively, when hydraulic fluid is supplied to an opposite second end of the first pivoting arm piston/cylinder 52, the overall axial length of each first pivoting arm piston/cylinder 52 thereby decreases so that the arm coupling linkage 80 and the second end of the second pivoting arm member 48 move and pivot, about the first pivoting arm member pivot axis 50′, away from its axially aligned configuration and toward a desired angled configuration, an example of which is shown in FIGS. 20-22, so as to form a desired angle with the first pivoting arm member 36. It is to be appreciated that the first pivoting arm piston(s)/cylinder(s) 52 is able to pivot the arm coupling linkage 80 and the second pivoting arm member 48 relative to the first pivoting arm member 36 over an angle of about 45° to 100°, typically about 70°.

At least one and preferably a pair of side by side second pivoting arm piston(s)/cylinder(s) 52′ is/are provided to facilitate pivoting motion of the second pivoting arm member 48 with respect to the arm coupling linkage 80 and the first pivoting arm member 36 into a desired angled position (see FIGS. 20-22). A first cylinder end of each second pivoting arm piston/cylinder 52′ is affixed to a surface of the second pivoting arm member 48 while an opposite piston end thereof is affixed to the arm coupling linkage 80. When hydraulic fluid is supplied to a first end of each second pivoting arm piston/cylinder 52′, an overall axial length of each second pivoting arm piston/cylinder 52′ increases so that the second pivoting arm member 48 pivots away from the arm coupling linkage 80 and the first pivoting arm member 36, about the second pivoting arm member pivot axis 50′, toward a substantially axially aligned configuration with the first pivoting arm member 36 (see FIGS. 17 and 18, for example). Alternatively, when hydraulic fluid is supplied to an opposite second end of each first pivoting arm piston/cylinder 52, the overall axial length of each first pivoting arm piston/cylinder 52 thereby decreases so that the second pivoting arm member 48 moves and pivots, about the second pivoting arm member pivot axis 50′, toward the arm coupling linkage 80 and the first pivoting arm member 36 away from the axially aligned configuration to a desired angled configuration, an example of which is shown in FIGS. 20-22, for example. It is to be appreciated that each second pivoting arm piston/cylinder 52 is able to pivot the second pivoting arm member 48 relative to the arm coupling linkage 80 and the first pivoting arm member 36 over an angle of about 45° to 100°, typically about 70°. It is to be appreciated that actuation of all of the first and second pivoting arm pistons/cylinders 52, 52′ provide a range of motion for the first pivoting arm section 18 of about 90° to 200° or so, typically about 140°.

Each of the first and the second pivoting arm pistons/cylinders 52, 52′ are typically operated simultaneously with one another and in the same direction. That is, hydraulic fluid is supplied to the same end of each of the first and the second pivoting arm pistons/cylinders 52, 52′ so that they are all simultaneously actuated either to increase or decrease their axial lengths and thereby achieve the desired angled configuration of the first pivoting arm section 18.

A first end of a first fixed length tube 82, of the second pivoting section 24, is fixedly attached to the second end of the second pivoting arm member 48. A first end of a second fixed length tube 84, of the second pivoting section 24, is attached to the second end of the first fixed length tube 82 by a conventional hydraulic second pivoting section worm gear 86. The second pivoting section worm gear 86 defines a second pivoting section axis 86′ which permits the second fixed length tube 84 and the attached implement 22 to pivot or rotate, relative to the first fixed length tube 82 and a remainder of the combined boom/arm 14.

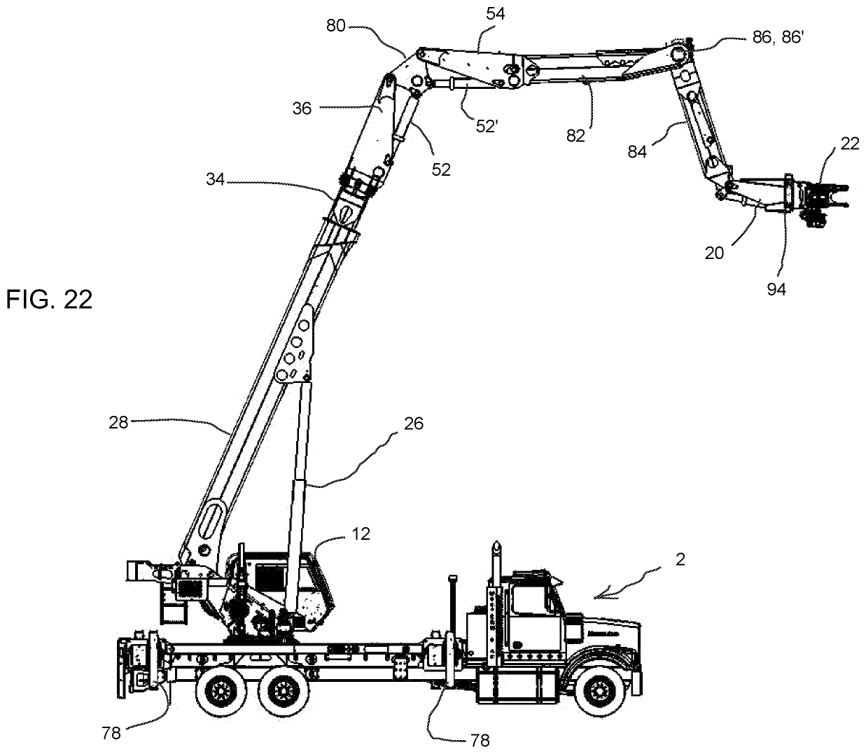

When hydraulic fluid is supplied to a first port of the second pivoting section worm gear 86, the second pivoting section worm gear 86 gradually rotates in a first rotational direction, e.g., clockwise in FIG. 19, toward both the boom/cab framework 10 and the ground, e.g., from the position shown in FIG. 19 toward the position shown in FIG. 22. When hydraulic fluid is supplied to a second port of the second pivoting section worm gear 86, the second pivoting section worm gear 86 gradually rotates in an opposite second rotational direction, e.g., counter clockwise, away from both the boom/cab framework 10 and the ground, e.g., from the position shown in FIG. 22 toward the position shown in FIG. 19. Typically, the second pivoting section worm gear 86 permits relative rotation between the first fixed length tube 82 and the second fixed length tube 84 over an angle of about 200° to 300° or so, typically about 240°.

A first end of the implement manipulating section 20 is pivotably attached to the second end of the second fixed length tube 84 by a pin/bolt 88 which forms a pivotable connection between those components and defines an implement pivot axis 88′. A base of an implement leverage arm 90 is also pivotably attached to the pin/bolt 88. First and second implement cylinders 92, 92′ are provided to facilitate pivoting movement of the implement manipulating section 20 with respect to the second fixed length tube 84, over a desired range of movement. A first piston end of the first implement cylinder 92, for example, is attached to the second fixed length tube 84 while the opposite cylinder end the first implement cylinder 92 is pivotably attached to the free end of the implement leverage arm 90. A first piston end of the second implement cylinder 92′, for example, is attached to the implement manipulating section 20 while the opposite cylinder end the first implement cylinder 92′ is also pivotably attached to the free end of the implement leverage arm 90. It is to be noted that the first and the second implement cylinders 92, 92′ are slightly offset from one another at their connection with the implement leverage arm 90. The first and the second implement cylinders 92, 92′ are typically operated simultaneously with one another and in the same actuation direction in order to move the implement manipulating section 20 in a desired rotational or pivoting direction.

When hydraulic fluid is supplied to a first end of each of the first and the second implement cylinders 92, 92′, the overall axial lengths of each of the first and the second implement cylinders 92, 92′ increase so that a second end of the implement manipulating section 20, along with the attached implement 22, are pivoted, about the implement pivot axis 88′, in a counter clockwise rotational direction, e.g., upwardly away from the ground in FIG. 19. Alternatively, when hydraulic fluid is supplied to an opposite second end of each of the first and the second implement cylinders 92, 92′, the overall axial lengths of each of the first and the second implement cylinders 92, 92′ thereby decrease so that the second end of implement manipulating section 20, along with the attached implement 22, is pivoted, about the implement pivot axis 88′, in a counter clockwise rotational direction, e.g., downwardly toward the ground in FIG. 19. The first and second implement cylinders 92, 92′, in cooperation with the implement leverage arm 90, are generally able to manipulate or pivot the implement manipulating section 20, as well as the attached implement 22, relative to a remainder of the combined boom/arm 14 about an angle of 150°-200°+70°.

A first portion of a rotatable coupling 94, such as an implement worm gear which facilitates rotation of the supported implement 22 over an angle of 360° in either rotational direction, is fixedly attached to the second end of the implement manipulating section 20. The implement 22 is either fixedly or releasably attached, by a conventional disconnect coupling, to the second portion of the rotatable coupling 94. The rotatable coupling 94 facilitates, when desired, replacement of the attached implement 22, by the operator, with another desired implement. As noted above, the implement 22 may be, for example, a conventional grappler device, (with or without an integrated chain saw), a mobile chipper, a concrete pulverizing device, etc. As such 360° rotatable coupling 94 for the desired implement 22 is conventional and well known in the art, a further detailed discussion concerning the same is not provided.

As with the previous embodiment, the boom vehicle 2 is equipped with a number of deployable/retractable outriggers 78, e.g., preferable two pairs of spaced apart outriggers 78 located along each side of the boom vehicle 2. As is conventional in the art, once these outriggers 78 are deployed, they assist with stabilizing the boom vehicle 2 during operation thereof. As such deployable/retractable outriggers 78 are conventional and well known in the art, a further detailed discussion concerning the same is not provided.

It is to be appreciated that the first and the second pivoting arm member pivot axes 50′, the second pivoting section axis 86′ and the implement pivot axis 88′ all extend generally parallel to one another and parallel to the combined boom/arm pivot axis 30′. However, the lateral folding pivot axis 44′ extends substantially normal to each of the first and the second pivoting arm member pivot axes 50′, the second pivoting section axis 86′, the implement pivot axis 88′ and the combined boom/arm pivot axis 30′. In the fully retracted state of the combined boom/arm 14 (as shown in FIG. 19), the lateral folding pivot axis 44′ is located closer to the combined boom/arm pivot axis 30′ than to the pivotal connection 88 of the desired implement 22 to the implement manipulating section 20.

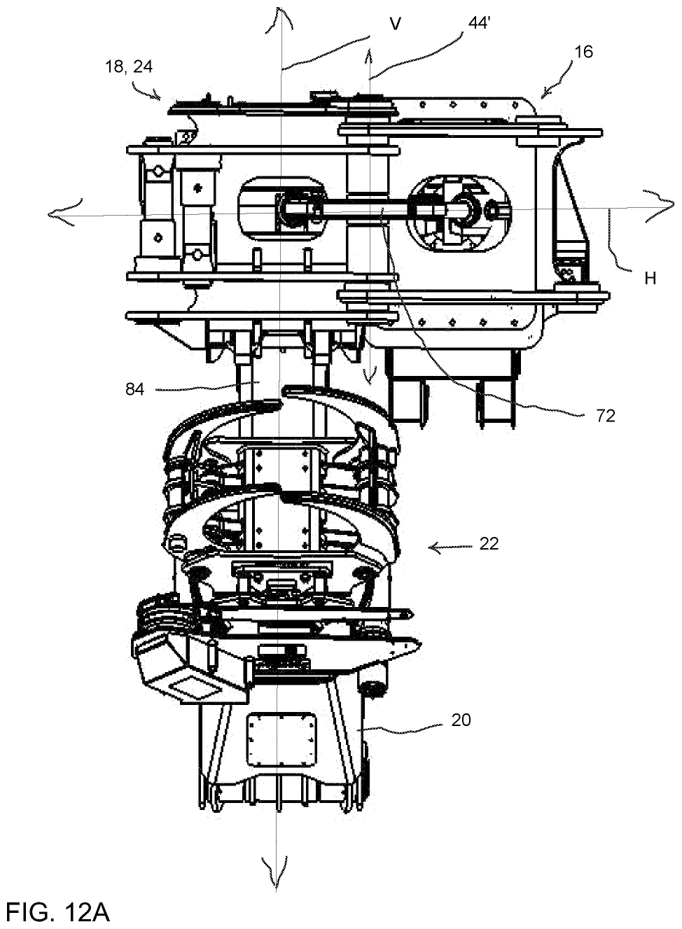

When the combined boom/arm 14 in its both completely folded and stored configuration (see FIGS. 12 and 13), to facilitate travel of the boom vehicle position, as well as when the combined boom/arm 14 is in its axially aligned configuration (see FIGS. 17 and 18), the first and the second pivoting arm member pivot axes 50′, the second pivoting section axis 86′, the implement pivot axis 88′ and the combined boom/arm pivot axis 30′ are all parallel to one another while the lateral folding pivot axis 44′ generally extends normal to all of those axes. In the completely folded and stored configuration, see FIGS. 12 and 13 for example, at least the base telescoping section 16 and the first pivoting arm section 18 and a portion of the second pivoting section 24 all lie generally in a common horizontal plane H—see FIG. 12A. Both the first pivoting arm section 18 and the second pivoting section 24 are located closely adjacent, but laterally/horizontally offset and parallel with respect to the base telescoping section 16. In addition, in the completely folded and stored configuration, see FIGS. 12 and 13 for example the first pivoting arm section 18, the second pivoting section 24 and the implement manipulating section 20 all lie generally in a common vertical plane V while a portion of the implement and a portion of the implement manipulating section 20 may rest on the vehicle framework 6. That is, in the completely folded and stored configuration, only the first pivoting arm section 18 and a portion of the second pivoting section 24 lie generally in both the common horizontal and vertical planes H, V.

Folding the Combined Boom/Arm for Transport

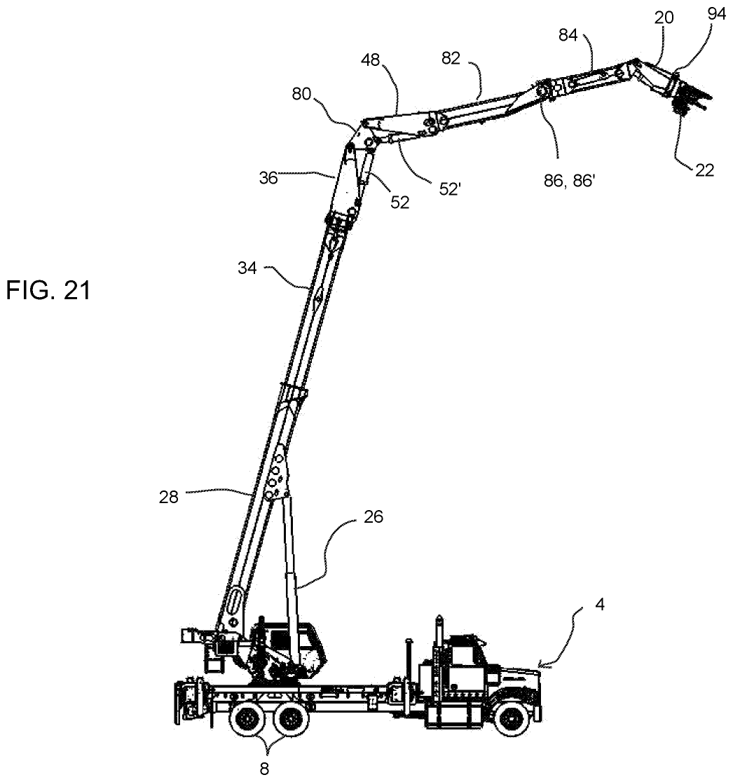

Assuming that the combined boom/arm 14 is in the configuration shown in FIG. 21, for example, and a desired job at the work site has been completed. The operator will then manipulate and collapse the combined boom/arm 14 so as to store the same on the boom vehicle 2 for transport, as generally shown in FIGS. 12 and 13. In order to achieve this, during a first step, hydraulic fluid is supplied to an opposite second end of the base telescoping piston/cylinder 32 to move the second end of the hollow inner telescoping tube 34 toward the second end of the hollow outer telescoping tube 28 and thereby minimize the overall axial length of the base telescoping section 16, as shown in FIG. 17.

During a second step, hydraulic fluid is supplied to the second end of each of the first and the second implement cylinders 92, 92′, so that the overall axial lengths of each of the first and the second implement cylinders 92, 92′ decreases and the second end of the implement manipulating section 20, along with the attached implement 22, are both pivoted, about the implement pivot axis 88′, in a clockwise rotational direction in FIG. 17, toward the ground and the base telescoping section 16. In addition, either at the same time or before or after, hydraulic fluid is also supplied to the first port of the second pivoting section worm gear 86 so that the second pivoting section worm gear 86 gradually rotates in the first second rotational direction, e.g., clockwise in FIG. 17, toward both the boom/cab framework 10 and the ground. Such rotation generally continues until the attached implement 22 is located closely adjacent the first pivoting arm section 18, see FIG. 16.

Next, hydraulic fluid is supplied to the opposite second end of the boom piston/cylinder 26 so that the overall axial length of the boom piston/cylinder 26 thereby decreases and the hollow outer telescoping tube 28 pivots (along with a remainder of the combined boom/arm 14), about the combined boom/arm pivot axis 30′, downwardly relative to and toward the boom/cab framework 10 and the ground, see FIG. 17. Once the combined boom/arm 14 is located either horizontally as in FIG. 17, or in a slightly elevated horizontal configuration relative to the ground or other surface (not shown), either the operator manually withdraws or removes the pin/bolt 42 from the aligned holes or the hydraulically actuated first and second pins/bolts 42 are actuated in the retracting direction, by the first and the second pin hydraulic cylinders, to retract and withdraw the hydraulically actuated first and second pins/bolts 42 from the aligned holes in the upper and lower plates 38, 40 to thereby partially disconnect the first pivoting arm member 36 from to the base telescoping section 16 while the second pin/bolt 44 remains permanently engaged with the aligned holes of the upper and lower plates 38, 40. Once the pin/bolt 42 or the hydraulically actuated first and second pins/bolts 42 are withdrawn, then the first pivoting arm section 18 is able to pivot or fold, in a generally lateral or horizontal direction, and be repositioned horizontally offset with respect to the base telescoping section 16.

During a fourth step, hydraulic fluid is then supplied to an opposite second end of each of the first and the second folding pistons/cylinders 46, 46′ so that the overall axial lengths of the first and the second folding pistons/cylinders 46, 46′ increase. As this occurs, the first pivoting arm member 36 of the first pivoting arm section 18 moves or pivots, about the lateral folding pivot axis 44′, so as to laterally and/or horizontally fold the first pivoting arm section 18 toward the base telescoping section 16 so that the first pivoting arm section 18 is, thereafter, located closely adjacent and parallel to the base telescoping section 16 of the combined boom/arm 14 and in a common horizontal plane, as shown in FIGS. 12 and 13.

Next, if this has not already occurred, the boom/cab framework 10 is then rotated, relative to the vehicle framework 6, so that the combined boom/arm 14 is, thereafter, located in the storage and transport position, as generally shown in FIGS. 12 and 13. If necessary, the boom piston/cylinder 26 may be again actuated so as to lower the combined boom/arm 14, about the combined boom/arm pivot axis 30′, into its lowermost horizontal configuration as shown in FIGS. 12 and 13 in which the combined boom/arm 14 extends parallel to the longitudinal axis L of the boom vehicle 2. With the combined boom/arm 14 in such configuration, the combined boom/arm 14 is sufficiently compact so that the boom vehicle 2 can safely and legally travel along a desired public roadway or highway. That is, the boom vehicle 2, with the folded combined boom/arm 14, as shown in FIGS. 12 and 13, has a height no greater than 13 feet, 6 inches and a width no greater than 8 feet 6 inches. Prior to travel, each one of the outriggers 78 is returned into is retracted and stowed position to permit unobstructed travel of the boom vehicle 2.

When use of the combined boom/arm 14 is desired, one the boom vehicle 2 arrives at the desired site, the above process is merely reversed to deploy the outriggers 78 and then unfold the combined boom/arm 14 into its operational configuration.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto. Although operations are depicted in the drawings in a particular order, this should not be understood as requiring that such operations be performed in the particular order shown or in sequential order, or that all illustrated operations be performed, to achieve desirable results.

Wherefore, I claim:

1. A boom vehicle comprising:
a vehicle framework;
a boom/cab framework being rotatably supporting by the vehicle framework;
a combined boom/arm being pivotably supported by the boom/cab framework about a boom/arm pivot axis;
the combined boom/arm comprising at least a base telescoping section, a first pivoting arm section, and an implement manipulating section;
an implement being supportable adjacent a free end of the combined boom/arm; and
the first pivoting arm section and the implement manipulating section together being laterally foldable, with respect to the base telescoping section, about a lateral folding pivot axis which extends normal to the combined boom/arm pivot axis to facilitate transport of the boom vehicle.

2. A boom vehicle comprising:
a vehicle framework;
a boom/cab framework being rotatably supporting by the vehicle framework;
a boom cab being supported on the boom/cab framework;
a combined boom/arm being pivotably supported by the boom/cab framework about a boom/arm pivot axis;
the combined boom/arm comprising at least a base telescoping section, a first pivoting arm section, a second pivoting section and an implement manipulating section;
an implement being supportable adjacent a free end of the combined boom/arm;
the first pivoting arm section, the second pivoting section and the implement manipulating section together being laterally foldable into a folded configuration, with respect to the base telescoping section, about a lateral folding pivot axis which extends normal to the combined boom/arm pivot axis; and
when the combined boom/arm is in the folded configuration, the base telescoping section, the first pivoting arm section and a portion of the second pivoting section all lie in a common horizontal plane, and the first pivoting arm section, the second pivoting section and the implement manipulating section all lie in a common vertical plane.

3. The boom vehicle according to claim 1, wherein a boom piston/cylinder is located between the boom/cab framework and the base telescoping section of the combined boom/arm for changing a position of the combined boom/arm with respect to the boom/cab framework, and
a base telescoping piston/cylinder facilitates adjustment of a position of a hollow inner telescoping tube of the base telescoping section with respect to a hollow outer telescoping tube of the base telescoping section.

4. The boom vehicle according to claim 3, wherein the first pivoting arm section comprises a first pivoting arm member and a second pivoting arm member which are both pivotably connected to a coupling linkage.

5. The boom vehicle according to claim 4, wherein a folding piston/cylinder facilitates lateral pivoting motion of the first pivoting arm section, from the folded configuration, into an operational axially aligned configuration, and vice versa, a first end of the folding piston/cylinder is affixed to the first pivoting arm member while an opposite end thereof is coupled, via a base linkage, to both the hollow inner telescoping tube and the first pivoting arm member.

6. The boom vehicle according to claim 4, wherein the first pivoting arm section is pivotably connected to the coupling linkage by a first pivoting arm member pin and at least one first pivoting arm cylinder, and the second pivoting arm section is pivotably connected to the coupling linkage by a second pivoting arm member pin and at least one second pivoting arm cylinder,

7. The boom vehicle according to claim 6, wherein a first fixed length tube, of the second pivoting section, is fixedly attached to the second pivoting arm member while a second fixed length tube, of the second pivoting section, is pivotably attached to the first fixed length tube.

8. The boom vehicle according to claim 7, wherein the first fixed length tube is pivotably attached to the second pivoting arm member by a hydraulic second pivoting section worm gear which permits the second fixed length tube to pivot or rotate, relative to the first fixed length tube over an angle of about 200° to 300° or so.

9. The boom vehicle according to claim 1, wherein the implement manipulating section is pivotably attached to a second end of the second fixed length tube by a pin/bolt which forms an implement pivot axis.

10. The boom vehicle according to claim 9, wherein an implement leverage arm is pivotably attached to the pin/bolt and first and second implement cylinders are provided to facilitate pivoting movement of the implement manipulating section with respect to the second fixed length tube over a desired range of movement.

11. The boom vehicle according to claim 1, wherein the implement is one of a grappler device, a grappler device with an integrated saw, a mobile chipper, and a concrete pulverizing device.

12. The boom vehicle according to claim 1, wherein first and second folding pistons/cylinders and a pivoting linkage facilitate lateral folding motion of the pivoting arm section relative to the base telescoping section.

13. The boom vehicle according to claim 12, wherein the first and second folding pistons/cylinders interconnect the pivoting linkage with the pivoting arm section and the base telescoping section respectively, and the pivoting linkage is also pivotably connected to rotatable about the lateral folding pivot axis.

14. The boom vehicle according to claim 1, wherein the boom vehicle is equipped with at least two deployable/retractable outriggers, and upon deployment of the at least two outriggers, the outriggers assist with stabilizing the boom vehicle during operation.

15. The boom vehicle according to claim 1, wherein when the combined boom/arm is in the folded configuration, the boom vehicle has a height no greater than 13 feet, 6 inches and a width no greater than 8 feet 6 inches.

16. The boom vehicle according to claim 1, wherein a total overall axial length of the combined boom/arm is approximately 80 feet or so.

17. A method of forming a boom vehicle, the method comprising:
providing a vehicle framework;
rotatably supporting a boom/cab framework on the vehicle framework;
supporting a boom cab on the boom/cab framework;
pivotably supporting a combined boom/arm on the boom/cab framework so as to rotate about a boom/arm pivot axis;
forming the combined boom/arm so as to comprise at least a base telescoping section, a first pivoting arm section, a second pivoting section and an implement manipulating section;
supporting an implement adjacent a free end of the combined boom/arm;
forming the first pivoting arm section, the second pivoting section and the implement manipulating section so as to be laterally foldable into a folded configuration, with respect to the base telescoping section, about a lateral folding pivot axis which extends normal to the combined boom/arm pivot axis; and
upon folding the combined boom/arm into the folded configuration, the base telescoping section, the first pivoting arm section and a portion of the second pivoting section all lie in a common horizontal plane, and the first pivoting arm section, the second pivoting section and the implement manipulating section all lie in a common vertical plane.
